(19) United States
(12) Patent Application Publication
(10) Pub. No.: US 2015/0006895 A1
(43) Pub. Date: Jan. 1, 2015

(54) DISTRIBUTED NETWORK SYSTEM

(71) Applicant: Maidsafe Foundation, Troon (GB)

(72) Inventor: David Irvine, Troon (GB)

(21) Appl. No.: 14/304,354

(22) Filed: Jun. 13, 2014

Related U.S. Application Data
(63) Continuation-in-part of application No. 14/260,032, filed on Apr. 23, 2014.
Application No. 14/260,032 is a continuation-in-part of application No. 13/656,826, filed on Oct. 22, 2012.
Application No. 13/656,826 is a continuation of application No. 13/362,384, filed on Jan. 31, 2012, now Pat. No. 8,788,803.
Application No. 13/362,384 is a continuation of application No. 12/476,229, filed on Jun. 1, 2009, now abandoned.

(51) Int. Cl. H04L 9/08; H04L 9/32; H04L 9/30

(52) U.S. Cl. CPC H04L 9/0816; H04L 9/30; H04L 9/3242; H04L 2209/24
USPC 713/171

(57) ABSTRACT

A method of storing data from a first node on a peer-to-peer network. The method includes creating a public and private key pair for a data item. The method also includes determining a hash value for the public key and assigning the hash value as a user identifier for the user of the node. The method also includes storing the public key within a distributed hash table of the peer-to-peer network. The user identifier corresponds to the key for the public key within the distributed hash table.

### CROSS REFERENCE TO RELATED APPLICATIONS

This application is continuation-in-part of U.S. Non-Provisional patent application Ser. No. 14/260,032 and a continuation-in-part of U.S. Non-Provisional patent application Ser. No. 13/656,826 which is a continuation of U.S. Non-Provisional patent application Ser. No. 13/362,384 with a Filing Date of Jan. 31, 2012, which is a continuation of U.S. Non-Provisional patent application Ser. No. 12/476,229 with a Filing Date of Nov. 18, 2009, which is a continuation of International Application PCT/GB2007/004421 with an International Filing Date of Nov. 21, 2007, and claiming priority to co-pending Great Britain Patent Application No. 0624053.5 filed on Dec. 1, 2006 and co-pending Great Britain Patent Application No. 0709759.5 filed May 22, 2007, all of which are relied on and incorporated herein by reference.

### BACKGROUND

Digital data is often stored on hard disks of individual personal computers (PCs) which invariably have memory and operational overhead restrictions. Storage of digital data on distributed systems such as the Internet is also possible, but requires specific storage servers to be available. In addition to such physical systems, data management elements such as security, repair, encryption, authentication, anonymity and mapping and such like are required to ensure successful data transactions and management via the Internet. Systems of messaging and voting exist today, but do not allow either authentication on what was voted for, or on line anonymity. There have been some attempts as listed below, but none of these systems operate as the example embodiments of the present disclosure.

Listed below is earlier documents for known individual elements, which do not disclose a distributed network system pursuant to the present disclosure.

Most perpetual data generation is allocated with time and calendar information, for example as described in patent documents US62669563, JP2001100633. These patent documents are not related to embodiments of the present disclosure, as embodiments of the present disclosure have no relation to calendaring, which demonstrates perpetual generation time related data. However, external devices such as communication terminals, for example as described in patent document JP2005057392 which concerns a hardware device which is not related to embodiments of the present disclosure, have been used for a plurality of packet switching uses to allow perpetual hand-off of roaming data between networks and a battery pack. In a patent document EP0944232, there is described around-the-clock accessibility of customer premises equipment interconnected to a broadband network which is enhanced by perpetual mode operation of a broadband network interface. In addition, perpetual data storage and retrieval in reliable manner in peer-to-peer (P2P) or distributed networks.

In patent documents WO9637837, TW223167B, U.S. Pat. No. 6,760,756 and U.S. Pat. No. 7,099,898, there are described methods of data replication and retention of data during failure.

A patent document WO200505060625 discloses a method of secure interconnection when failure occurs.

Authentication servers are known for user and data transaction authentication, for example as described in patent document JP2005311545 which describes a system wherein the application of ‘a digital seal’ to electronic documents conforms to the Electronic Signature Act. Such authentication is similar to a case of signing paper documents, but uses an application of an electronic signature through an electronic seal authentication system. The system includes:
I. client computers, to each of which a graphics tablet is connected;
II. an electronic seal authentication server and a PKI authentication server; and
III. an electronic seal authentication server.

Moreover, a patent document US2004254894 discloses an automated system for providing confirmed efficient authentication of an anonymous subscribers profile data.

In a patent document JP2005339247, there is described a server-based one-time-ID system which uses a portable terminal. Moreover, in a patent document US2006136317, there is disclosed bank drop down boxes which provide stronger protection by not transmitting any passwords or identifications (IDs). In a patent document US2006126848, there is disclosed a server centric, wherein a one-time-password or authentication phrase is employed, wherein the server centrix is not for use on a distributed network. Moreover, in a patent document US2002194484, there is disclosed distributed networks wherein all chunks of data are not individually verified, and wherein a given manifest is only re-computed after updates to files and hashes are applied and are for validation purposes only.

A patent document WO2006069158 is concerned with biometric data. There is described in a patent document US2006136514 a system for generating a patch file from an old version of data which consists of a series of elements and a new version of data which also consists of a series of elements. Moreover, as described in patent documents JP2006107316, US2005273603, EP1548979, authentication servers, therefore not a distributed networking principle as per embodiments of the present disclosure, are commonly used.

However, server and client exchange valid certificates can be used, for example as described in a patent document US2004255037. Instead of using servers, uses of information exchange system, namely semantic information, by a given participant for authentication can be used, for example as described in a patent document JP2004355358; again, this semantic information is stored and referenced unlike embodiments of the present disclosure.

Concepts of identity-based cryptography and threshold-secret sharing provides for distributed key management and authentication. Without any assumption of pre-fixed trust relationship between nodes, an ad hoc network works in a self-organizing way to provide for a key generation and key management service, which effectively solves a problem of single-point-of-failure in a traditional known public key infrastructure (PKI)-supported system, for example as described in a patent document US2006023887. Authenticating involves encryption keys for validation, for example as described in a patent document WO2005055162; such encryption keys are validated against known users unlike embodiments of the present disclosure. Moreover, for authentication, external housing are used, for example as described in a patent document WO2005034009. All of these systems require a lost, or whether distributed or not, record of authorised users and pass phrases or certificates and therefore unrelated to embodiments of the present disclosure.

Ranking, hashing for authentication can be implemented in a step-by-step manner, and empirical authentication of devices is beneficially implement upon digital authentication among a plurality of devices. Each of a plurality of authentication devices can uni-directionally generate a hash value of a low experience rank from a hash value of a high experience rank, and receive a set of high experience rank and hash value in accordance with an experience. In this way, the authentication devices authenticate each other's experience ranks, for example as described in a patent document US2004019788; there is described a system of hashing access against known identities, and providing a mechanism of effort-based access. Embodiments of the present disclosure do not rely or use such mechanisms.

In a patent document JP2001308845, there is described another method for authentication. Moreover, self-verifying certificates for computer systems, which use private and public keys-no chunking but for trusted hardware subsystems, are described in a patent document US2002080973; there is described a mechanism of self-signing certificates for authentication, which again is useful for effort-based computing, but not employed in embodiments of the present disclosure. Other authentication modes concern devices for exchanging packets of information as described in a patent document JP2001186186, as well as open-key certificate management data as described in a patent document JP10285156, and also certification for authentication as described in a patent document WO96139210. Authentication for a peer-to-peer (P2P) system is demonstrated by digital rights management, as described in a patent document US2003120928.

Known self-healing techniques are divided broadly into two classes. One class is a centralized control system that provides overall rerouting control from a central location of a network; in this approach, a rerouting algorithm and an establishing of alarm collection times become increasingly complex as the number of failed channels increases, and a substantial amount of time is taken to collect alarm signals and to transfer rerouting information in an event of a large number of channels of a multiplexed transmission system failing. The other class is a distributed approach in which rerouting functions are provided by distributed points of a given network. The following published documents as provided in Table 1 concern distributed rerouting approaches; these are all related to self-healing, but from a network pathway perspective and therefore are not relevant to embodiments of the present disclosure which utilize data- or data-chunk self-healing mechanisms.

TABLE 1
Earlier documents concerning distributed rerouting approaches

| Document | Detail |
|---|---|
| D1 | W. D. Grover, “The Self healing Network”, Proceedings of |
| | Grobecom ′87, November 1987. |
| D2 | H. C. Yang and S. Hasegawa, “Fitness: Failure Immunization |
| | Technology For Network Service Survivability”, Proceedings |
| | of Globecom ′88, December 1988. |
| D3 | H. R. Amirazizi, “Controlling Synchronous Networks With |
| | Digital Cross-Connect Systems”, Proceedings of Globecom |
| | ′88, December 1988. |

The document D1 is concerned with a restoration technique for failures in a single transmission system, and the document D2 relates to a “multiple-wave” approach in which route-finding packets are broadcast in multiple wave fashion in search of a maximum bandwidth until alternate routes having necessary bandwidths are established. One shortcoming of this multiple wave approach is that it takes a long recovery time. The document D3 also relates to fault recovery for single transmission systems and has a disadvantage in that route-finding packets tend to form a loop and hence a delay is likely to be encountered.

There is demonstrated by a system and method of communicating secure and tamperproof remote files over a distributed system, which redirects integrity check fail data to an install module for repairing purposes, as described in a patent document WO20566133); this patent document discloses an approach which relies on testing data from a central location and does not concern distributed chunking as employed in embodiments of the present disclosure. Moreover, tt also does not allow for multiple access and sharing of the testing and ownership of chunks. Furthermore, servers are used for self-healing, as described in a patent document US2004177156. Self-repairing is conducted by data overlay, and is built as a data structure on top of a logical space defined by a distributed hash table (DHT) in a peer-to-peer (P2P) network environment, as described in a patent document US2005187946; this patent document concerning Microsoft as applicant relates to DT networks; however there is no disclosure made to self-repair data, in contradistinction of embodiments of the present disclosure, but to self repair data storage locations, namely in P2P terms finding a nearest node. There is thus not described self-healing data, but merely a typical DHT and the availability of routes to data and providing multiple routes.

Identical communicating node elements are used for power delivery networks for self-repairing purposes, as described in a patent document US2005043858. Moreover, self-healing also relates to distributed data systems and, in particular, to providing high availability during performance of a cluster topology self-healing process within a distributed data system cluster. A cluster topology self-healing process is optionally performed in response to a node failure in order to replicate a data set stored on a failed node from a first node storing another copy of the data set to a second non-failed node, as described in a patent document US2004066741. An apparatus and method for self-healing of software beneficially rely on a distribution object in a directory services of a network to provide data for controlling distribution of software and installation of files associated therewith, as described in a US patent document U.S. Pat. No. 6,023,586. A technique for providing substantially instantaneous self-healing of digital communications networks is also known; digital data streams from each of N nearby sources are combined and encoded to produce N+M coded data streams using a coding algorithm. The N+M coded data streams are then each transmitted over a separate long haul communications link to a decoder, wherein any N of the N+M coded data streams can be decoded uniquely to produce the original N data steams, as described in a patent document EP0420648. Provision of a self-healing communications network which can be recovered from a failure in a short period of time even, if the failure has occurred in a multiplexed transmission line, is described in a US patent document U.S. Pat. No. 5,235,599) The above patent documents relate to known inventions that are based on clustering technology and not distributed computing or Internet-based computing; an associated cluster is simply many machines connected to create a larger machine. It is treated as a single machine with known user access and so forth, and is considerably different to embodiments of the present disclosure. The N+M coding schemes disclosed in the aforementioned patent documents are based on digital communications and reception links and are not related to embodiments of the present disclosure.

Attempts to moving towards attaining some limited aspects of self-encryption are described in following patent documents:

(a) A US patent document US2003/053053625 describes limitations of asymmetrical and symmetrical encryption algorithms, and particularly not requiring generating a key stream from symmetric keys, nor requiring any time synchronising, with minimal computational complexity and capable of operated at high speed. A serial data stream to be securely transmitted is first demultiplexed into a plurality N of encryptor input data stream. Corresponding input data slices are created which have a cascade of stages, include mapping and delay functions to generate corresponding output slices. These output slices are transmitted though a transmission channel. Decryption of the output slices involves applying inverse steps of a cascade of stages, equalizing delay function and mapping to generate output data slices. The output data streams are multiplexed. Associated encryptors and decryptors require no synchronizing or timing, and operate in simple stream fashion. There is employed N:N mapping which does not require expensive arithmetic computations to be performed and implemented in a table lookup. This provides robust security and efficiency. A significant difference between this approach and prior known cipher methods is that there is utilized a session key to derive processing parameters, for example tables and delays, of the encryptors and decryptors in advance of data transmission. There is circumvented a need to generate a key stream at real-time rates. There is also described an algorithm for generating parameters from a session key. This patent document if concerned with data communications and encrypting data in transit automatically and decrypting automatically at the remote end, and is very different in comparison to embodiments of the present disclosure.

(b) A US patent document US2002/184485 is concerned with addressing secure communication, by encrypting messages, namely by employing SSDO-self signing of document objects, such that only a known given recipient in possession of a secret key can read the messages and verify the messages, such that text and origin of the messages can be verified. Both capabilities are built into the messages that can be transmitted over Internet, and decrypted or verified by computers implementing a document representation language that supports dynamic content, for example any standard web browser, such that elaborate procedures to ensure transmitting and receiving computers have mutually similar software are not necessary. A given encrypted message, or one encoded for verification, can carry within itself all information needed to specify an algorithm needed for decrypting the encrypted message. There is further described a key pair encryption and validation of same software. However, such an approach is not employed in embodiments of the present disclosure, wherein key pairs are used for asymmetric encryption of some data, but this is optionally used with the RSA encryption ciphers and not in the manner described above which is more for validation purposes.

A range of limited methods of self-encryption have been developed, for example as provided in Table 2.

TABLE 2
Limited methods of self-encryption

| Document | Detail |
|---|---|
| EP1182777 | A system for radomisation-encryption of digital data |
| | sequence with freely selectable is described. |
| CN 1658553 | A code key calculation encryption mode via use of a |
| | server; this is a key generating arrangement and not self |
| | encryption as employed in embodiments of the present |
| | disclosure |
| U.S. Pat. No. 6,028,527 | self-test mode |
| U.S. Pat. No. 4,760,598 | An encryption system for randomising data signal for |
| | transmission (not storing) and reproducing information at |
| | a receiver. |
| JP2005328574 | Use of private encryption keys into components and |
| | sending them to trusted agents, rather than self |
| | encryption as per embodiments of the present |
| | disclosure. |
| U.S. Pat. No. 6,009,177 | A cryptographic system with key escrow feature, rather |
| | than self encryption as per embodiments of the present |
| | disclosure. |
| U.S. Pat. No. 6,385,316 | A method including steps of first encoding one set of |
| | message signal with first keyed transformation. |
| U.S. Pat. No. 6,370,649 | A self-modifying fail-safe password system. |
| RU2120700 | Time-based encrypting method involving splitting voice |
| | signal into time intervals, random permutations, and so |
| | forth. |
| US2003/046568 | Use of hardware decryption module (HDM). |
| US200/6149972 | Realizing data security storage and algorithm storage by |
| | means of semiconductor memory device. |
| US20020428080 | Use of a certificate from a certificate server. |
| EP1422865 | Use of certificates for encrypting communications. |
| US2006/020788 | Use of a self-service terminal for encryption and |
| | transmission of data. |
| US2005/047597 | A method for implementing security communication by |
| | employing an encryption algorithm. |
| US2004/190712 | A method of data encryption-block encryption variable |
| | length (BEVL) encoding, which overcomes weakness of |
| | a CMEA algorithm. |
| CN 1627681 | An encrypted cipher code for secure data transmission. |
| US2005/232424 | A method and system for encrypting streamed data, |
| | employing fast set-up single use key and self- |
| | synchronising. |
| US2004/199768 | For security, generation of MAC for data integrity, placing |
| | electronic signature, by using a TREM software module. |

None of the above systems in Table 2 utilise self encryption as per embodiments of the present invention, and are related to voice and data transmissions, or include hardware controllers or servers.

In a US patent document U.S. Pat. No. 6,859,812, there is disclosed a system and method for differentiating private and shared files, wherein clustered computers share a common storage resource, namely Network-Attached Storage (NAS) and Storage Area Network (SAN), therefore is not a distributed implementation as per embodiments of the present disclosure. Moreover, a US patent document U.S. Pat. No. 5,313,646 concerns a system which provides a copy-on-write feature which protects the integrity of shared files by automatically copying a shared file into a given users private layer, when the given user attempts to modify a shared file in a back layer; this is a different technology again and relies on user knowledge, and is not anonymous. In a patent document WO02/095545, there is disclosed a system using a server for private file sharing which is not anonymous.

A computer system having plural nodes interconnected by a common broadcast bus is disclosed in a US patent document U.S. Pat. No. 5,117,350. In a US patent document U.S. Pat. No. 5,423,034, there is disclosed how each file and level in a directory structure has network access privileges. There is employed a file directory structure generator and retrieval tool having a document locator module that maps the directory structure of files stored in memory to a real world hierarchical file structure of files. Therefore, such an arrangement is not a distributed across public network, nor anonymous or self encrypting; embodiments of the present disclosure do not use broadcasting in such a manner.

Today, systems provide secure transactions through encryption technologies such as Secure Sockets Layer (SSL), Digital Certificates, and Public Key Encryption technologies. The systems today address hackers through technologies such as Firewalls and Intrusion Detection systems. Moreover, merchant certification programs are designed to ensure that a given merchant has adequate inbuilt security to assure reasonably a given that the consumer's will be secure. These systems also ensure that a given vendor will not incur a charge back by attempting to verify the given consumer through secondary validation systems such as password protection and, eventually, Smart Card technology. Network firewalls are typically based on packet filtering which is limited in principle, since rules employed for such firewalls that judge which packets to accept or reject are based on subjective decisions. Even VPNs (Virtual Private Networks) and other forms of data encryption, including digital signatures, are not really safe because information can be stolen before data encryption processes are implemented, as default programs are allowed to do whatever they like to other programs or to their data files or to critical files of the operating system. In a patent document CA247150, data encryption is performed by automatically creating an unlimited number of Virtual Environments (VEs) with virtual sharing of resources, so the programs in each VE think that they are alone on a given computer; in contradistinction, embodiments of the present disclosure take a totally different approach to security and obviates the requirement of much of the above, in particular as described in a patent document CA2471505. In a US patent document U.S. Pat. No. 6,185,316, there is disclosed security via use of a fingerprint imaging testing bit of code using close false images to deter fraudulent copying; again, this is different to methods employed in embodiments of the present disclosure which do not store images at all, and certainly not in any database.

There are currently several types of centralised file storage systems that are used in business environments. One such system is a server-tethered storage system that communicates with its end users via a local area network, or LAN. The end users send requests for the storage and retrieval of files via the LAN to a file server, which responds by controlling storage and/or retrieval operations to provide or store the requested files. While such a system works well for smaller networks, there is a potential bottleneck at an interface between the LAN and the file storage system.

Another type of centralised storage system is a storage area network, which is a shared, dedicated high-speed network for connecting storage resources to servers. While the storage area networks are generally more flexible and scalable in terms of providing end user connectivity to different server-storage environments, the systems are also more complex. The systems require hardware, such as gateways, routers, switches, and are thus costly in terms of hardware and associated software acquisition.

Yet another known type of storage system is a network attached storage system in which one or more special-purpose servers handle file storage over a LAN.

Another known file storage system utilizes distributed storage resources resident on various nodes, or computers, operating on an associated system, rather than a dedicated centralised storage system. These are distributed systems, with the clients communicating in a peer-to-peer (P2P) manner to determine which storage resources to allocate to particular files, directories and so forth. These systems are organized as global file stores that are physically distributed over the computers on the system. A global file store is a monolithic file system that is indexed over the system as, for example, a hierarchical directory. The nodes in the systems use Byzantine agreements to manage file replications, which are used to promote file availability and/or reliability. The Byzantine agreements require rather lengthy exchanges of messages and thus are inefficient and even impractical for use in a system in which many modifications to files are anticipated. In a patent document US2002/11434, there is disclosed a peer-to-peer (P2P) storage system which employs a storage coordinator that centrally manages distributed storage resources. A difference here is a requirement of a storage broker, making the storage system not fully distributed. Embodiments of the present disclosure also differ in that they do not employ central resources for any of their system, and also encrypt data for security as well as provide self healing in a distributed manner.

In a US patent document U.S. Pat. No. 7,010,532, there is disclosed improved access to information stored on a storage device. A plurality of first nodes and a second node are mutually coupled via a communications pathway, the second node being coupled to the storage device for determining metadata including block address maps to file data in the storage device.

In a Japanese patent document JP2003273860, there is disclosed a method of enhancing the security level during access of an encrypted document including encrypted content. A document access key for decrypting an encrypted content within an encrypted document is stored in a management device, and a user device wishing to access the encrypted document transmits its user ID and a document identification key for the encrypted document, which are encrypted by a private key, together with a public key to the management device to request transmission of the document access key. In contradistinction, embodiments of the present disclosure never transmit user identification (ID) or login information in an associated network at all. Moreover, embodiments of the present disclosure do not require management devices of any form.

In a Japanese patent document JP2002185444, there is disclosed improvements to security in networks and the certainty for satisfying processing requests. In the case of user registration, a print server forms a secret key and a public key, and delivers the public key to a user terminal, which forms a user ID, a secret key and a public key, encrypts the user ID and the public key by using the public key, and delivers them to the print server.

It is known to use private and public keys of users, as described in a US patent document U.S. Pat. No. 6,925,182, which are encrypted with a symmetric algorithm by using individual user identifying keys and are stored on a network server making it a different proposition from a distributed network.

In a patent document US2005/091234, there is described data chunking system which divides data into predominantly fixed-sized data chunks, such that duplicate data may be identified. This is associated with storing and transmitting data for distributed networks. Moreover, in a patent document US2006/206547, there is disclosed a centralised storage system, whilst a patent document US2005/004947 discloses a PC-based file system. Furthermore, a patent document US2005256881 discloses data storage in a place defined by a path algorithm; this is a server-based duplicate removal arrangement, and not necessarily concerned with encrypting data, unlike embodiments of the present disclosure which do both and do not require servers.

Common e-mail communications of sensitive information are often in plain text and are subject to being read by unauthorized code (for example malware) on the senders system, during transit (for example by governmental organisations such as GCHQ, NSA and CIA) and by unauthorized code on the receivers system (again malware). Where there is a high degree of confidentially required, use of a combination of hardware and software is able to secure data. A high degree of security to a computer or several computers connected to the Internet or a LAN as disclosed in a patent document US20021099666; a hardware system is used which consists of a processor module, a redundant non-volatile memory system, such as dual disk drives, and multiple communications interfaces. This type of security system must be unlocked by a pass phrase to access data, and all data is transparently encrypted, stored, archived and available for encrypted backup. A system for maintaining secure communications, file transfer and document signing with PKI, and a system for intrusion monitoring and system integrity checks are provided, logged and selectively alarmed in a tamper-proof, time-certain manner.

In a patent document WO2005093582, there is disclosed a method of encryption, wherein data is secured in a receiving node via use of a private tag for anonymous network browsing. However, other numerous encryption methods are also available such as provided in Table 3.

TABLE 3
Known methods of encryption

| Patent document | Detail |
|---|---|
| WO02052787 | Implantation of a Reed Solomon algorithm which |
| | ensures data is coded in parabolic fashion for self- |
| | repairing and storage. |
| WO02052787 | Storage involves incremental backup. |
| US2006/177094 | Use of stenographic techniques for encryption. |
| CN1620005 | Use of cipher keys for encryption. |
| US2006/107048 | Concerns encryption for non-text data. |
| US2005/108240 | Discloses user keys and randomly generated leaf |
| | node keys for achieving encryption. |

Embodiments of the present disclosure uses none of these methods of encryption in Table 3, and in particular ensures all chunks are unique and do not point to another for security, namely a drawback issue with Reed Solomon and N+K implementations of parabolic coding.

In a patent document WO2005/060152, there is disclosed a digital watermark representing a one-way hash which is embedded in a signature document and is used for electronic signing. Mostly encrypted document signing is associated with legal documents, for example on-line notary and so forth, for example as described in patent document US2006/161781, and a signature verification as described in a patent document U.S. Pat. No. 6,381,344). In a patent document WO0182036, there is disclosed a system and method for signing, storing, and authenticating electronic documents using public key cryptography. The system comprises a document service computer cluster connected to user computers, document owner server computers, and registration computers via a network such as for example, the internet or the World Wide Web. In a patent document WO00/13368, there is disclosed is situation wherein both a data object and a signature data are encrypted. None of these systems are designed or allow for distributed signing networks unlike embodiments of the present disclosure.

In a patent document U.S. Pat. No. 6,912,660, there is disclosed a method for parallel approval of an original electronic document. A document authentication code (DAC 0) is generated, linked to the original electronic document. Subsequent approvals of the document generate a DAC x related to those specific approvals. Such an approach is unrelated to embodiments of the present disclosure, in that this patent document U.S. Pat. No. 6,912,660 is a document approval system, namely one which allows a document to have multiple signatories to authenticate approval, wherein embodiments of the present disclosure do not do this at all.

A US patent document U.S. Pat. No. 6,098,056 discloses a system and method for controlling access rights to, and security of, digital content in a distributed information system, for example in a network such as the Internet. The network includes at least one server coupled to a storage device for storing the limited-access digital content encrypted using a random-generated key, known as a Document Encryption Key (DEK). The DEK is further encrypted with the server's public key, using a public/private key pair algorithm and placed in a digital container stored in a storage device and including as a part of the meta-information which is in the container. The client's workstation is coupled to the server, namely one of the many differences distinguishing as an approach from embodiments of the present invention, for acquiring the limited access digital content under the authorized condition. A Trusted Information Handler (TIH) is validated by the server after the handler provides a data signature and type of signing algorithm to transaction data descriptive of a purchase agreement between a given client and an owner od the content. After the handler has authenticated, the server decrypts the encrypted DEK with its private key and re-encrypts the DEK with the handlers public key ensuring that only the information handler can process the information. The encrypted DEK is further encrypted with the client's public key personalizing the digital content to the client. The client's program decrypts the DEK with his private key and passes it along with the encrypted content to the handler which decrypts the DEK with his private key and proceeds to decrypt the content for displaying to the client.

In a US patent document U.S. Pat. No. 5,436,972, there is disclosed a method for preventing inadvertent betrayal by a trustee of escrowed digital secrets. After unique identification data describing a user has been entered into a computer system, the user is asked to select a password to protect the system. Moreover, in a US patent document U.S. Pat. No. 5,557,518, there is disclosed a system to open electronic commerce using trusted agents. Furthermore, in a US patent document U.S. Pat. No. 5,557,765, there is disclosed a system and method for data recovery; an encrypting user encrypts a method using a secret storage key (KS) and attaches a Data Recovery Field (DRF), including an Access Rule Index (ARI) and the KS to the encrypted message.

In a patent document U.S. Pat. No. 5,590,199, there is disclosed a system for authenticating and authorizing a user to access services on a heterogeneous computer network. The system includes at least one workstation and one authorization server connected to each other through a network.

Patent documents US2006/123227 and WO02/21409 concern effort measuring techniques to validate signatures without a requirement for a central body or central messaging entity.

Attempts to moving towards attaining some limited aspects of self-encryption are demonstrated by:

(a) a patent document US20031053053625 which discloses limitations of asymmetrical and symmetrical encryption algorithms, and describes a system particularly not requiring generation of a key stream from symmetric keys, nor requiring any time synchronizing, with minimal computational complexity and capable of operating at high speed. A serial data stream to be securely transmitted via the system is first demultiplexed into a plurality N of encryptor input data streams. Input data slices are created which have a cascade of stages, include mapping and delay functions to generate output slices. These output slices are transmitted though a transmission channel. A decryptor applies inverse steps of a cascade of stages, applies an equalizing delay function and mapping to generate output data slices. The output data streams are multiplexed. The encryptor and decryptor require no synchronizing or timing and operate in simple stream fashion. N:N mapping is employed which does not require expensive arithmetic and is implemented in a table lookup. This provides robust security and efficiency. A significant difference between this approach and known prior cipher methods is that the session key is used to derive processing parameters, namely tables and delays, of the encryptor and decryptor in advance of data transmission. Algorithms for generating parameters from a session key are disclosed. This is a data communications network and not related to embodiments of the present disclosure.

(b) a patent document US2002/184485 addresses secure communication, by encryption of messages, namely SSDO-self signing document objects, such that only a known recipient in possession of a secret key can read the message and verify the message, such that text and origin of message can be verified. Both capabilities are built into message that can be transmitted over the Internet and decrypted or verified by a computer implementing a document representation language that supports dynamic content, for example any standard web browser, such that elaborate procedures to ensure transmitting and receiving computers have same software are no longer necessary. Encrypted messages, or one encoded for verification, can carry within itself all information needed to specify a suitable algorithm needed for decryption.

A patent document US2004/117303, there is disclosed an anonymous payment system, which is designed to enable users of the Internet and other networks to exchange cash for electronic currency that may be used to conduct commercial transactions world-wide through public networks. Moreover, a patent document US2005289086 discloses an anonymity for web registration which allows payment system. Furthermore, a patent document US2002/073318 describes use of servers, wherein a system employs effort-based trust in combination with use of anonymous keys to transact, and with use of a public key to buy non-anonymous credits. Each of these is a centrally controlled system and does not provide a mechanism to transfer credits or cash to anonymous accounts. Many of these actually require user registration on a web site.

A patent document US2003/163413 discloses a method of conducting anonymous transactions over the Internet to protect consumers from identity fraud. The method involves the formation of a Secure Anonymous Transaction Engine to enable any consumer operating over an open network, such as the Internet, to browse, to collect information, to research, to shop, and to purchase anonymously. The Secure Anonymous Transaction Engine components provide a highly secure connection between a given consumer and a given provider of goods or services over the Internet by emulating an in-store anonymous cash transaction, although conducted over the Internet. This again is server-based and requires user registration.

With regard to cash transfers, a truly anonymous purchase is one in which a given purchaser and a given seller are unknown to each other, an associated purchase process is not witnessed by any other person, and an exchange medium used is cash. Such transactions are not a norm. Even cash transactions in a place of business are typically witnessed by salespersons and other customers or bystanders, if not recorded on videotape as a routine security measure. Conversely, common transaction media such as payment by personal check or credit card represent a clear loss of anonymity, since the given purchaser's identity as well as other personal information is attached to the transaction, for example drivers license number, address, telephone number, and any information attached to an associated name, credit card, or drivers license number. Thus, although a cash transaction is not a truly anonymous purchase, it provides a considerably higher degree of purchase anonymity than a transaction involving a personal check or credit card, and affords perhaps a highest degree of purchase anonymity which is contemporarily achievable. The use of cash, however, has limitations, especially in a context of electronic commerce.

In a patent document WO0203293, there are disclosed methods, systems, and devices for performing transactions via a communications network such as the Internet, while preserving the anonymity of at least one party involved. A transaction device is linked to an anonymous account to allow a given party to preserve an equivalent level of anonymity as the use of cash when making a transaction at a traditional brick-and-mortar business as well as in a virtual world of electronic commerce. As such, the transaction device may be considered equivalent to a flexible and versatile cash wallet. In this way, there is combined the desirable features of cash (namely anonymity, security, and acceptance) and of electronic commerce (namely speed, ease, and convenience). This, like the next patent document described, requires a hardware based device unlike embodiments of the present disclosure.

In a patent document EP0924667, there is described a distributed payment system for cash-free payment with purse chip cards using the Internet. The system consists of a client system which is, for example, installed at the customer site and a server system which is, for example, installed at a dealer.

In a patent document U.S. Pat. No. 6,299,062, there is disclosed an electronic cash system for performing an electronic transaction using an electronic cash, comprises at least one user apparatus which is each capable of using the electronic cash; an authentication centre apparatus, for receiving a user identity information, a corresponding public key along with a certificate issue request from one of the user apparatus and for issuing a certificate for the user apparatus's public key after confirming the identity of the corresponding user. This again requires hardware and user registration to the system.

In a patent document US2004/172539, there is disclosed a method for generating an electronic receipt in a communication system providing a public key infrastructure, comprising the steps of receiving by a second party a request message from a first party, the request message comprising a transaction request and a first public key based on a secret owned by the first party and wherein the secret is associated with at least the secret of a further public key of the first party, namely server-based.

In a patent document WO0219075, there is disclosed a publicly-accessible, independent, and secure host Internet site that provides a downloadable agent program to any anonymous client personal computer (PC), with a agent program for generating within the client PC a registration checksum based upon a given document to be registered.

In a patent document US2003/159032, there is disclosed automatically generating unique, one-way compact and mnemonic voter credentials that support privacy and security services. There is disclosed a voting system, voting organization, or voting game wherein participants need to be anonymous and/or must exchange secrets and/or make collective decisions. Moreover, in a patent document US2002077887, there is described a method requiring registration and initial knowledge of a given person who receives a ballot, and requires use of a server; there is disclosed an architecture that enables anonymous electronic voting over the Internet using public key technologies. Using a separate public key/private key pair, the voting mediator validates the voting ballot request. In a German patent document DE10325491, there is discloses a hardware device, wherein a voting method has an electronic ballot box for collecting encoded electronic voting slips and an electronic box for collecting the decoded voting slips; a given voter fills out his/her voting slip at a computer and authenticates his/her vote with an anonymous signature setting unit.

In a US patent document US2004/024635, there is disclosed a distributed network voting system which is hardware-based, requiring servers for its implementation; there is employed a server for processing votes cast over a distributed computing network. The server includes memory storage, data identification, an interested party and a processor in communication with the memory. The processor operates to present an issue to a user of a client computer, receive a vote on the issue from the user, and transmit data relating to the vote to the interested party based upon the data identifying the interested party stored in the memory. The processor further operates to generate a vote status cookie when the user submits the vote, transmit the vote status cookie to the client for storage, and transmit data to the user that prompts the user to provide authentication data relating to the user, who then receives authentication data relating to the user and authenticate the user based on the authentication data.

In a patent document WO03/098172, there is disclosed a modular monitoring and protection system with distributed voting logic.

In a patent document US2006/112243, there is disclosed a hard disk mapping, wherein data is copied locally to generate a copy and then a machine decides whether or not it can use or copy, and whether or not it can update the copy. In a European patent document EP1049291, there is disclosed remote device monitoring using pre-calculated maps of equipment locations. These are hardware based data mapping systems and not related. Aforementioned prior art highlights separate existence of elements such as storage, security, repairing, encryption, authentication, anonymity, voting and mapping and so forth for data transaction and storage via internet. There is some limited linkage between a few of the individual elements, but none are inter-linked to provide comprehensive solution for secure data storage and transmittance via Internet utilisation. Embodiments of the present disclosure described below provide solutions to address a lack of suitable systems and methods for providing higher security and anonymity, and provide an inexpensive solution for secure internet data storage and transmittance with other added benefits.

### SUMMARY

According to an example embodiment, the invention is a method of storing data from a first node on a peer-to-peer (P2P) network. The method includes creating a public and private key pair from a data item. The method also includes determining a hash value for the public key and assigning the hash value as a user identifier for the user of the node. The method also includes storing the public key within a distributed hash table of the peer-to-peer (P2P) network. The user identifier corresponds to the key for the public key within the distributed hash table.

In one aspect, the present disclosure concerns a computer-implemented method of storing data of a first node on a peer-to-peer network in a protected form. The method includes obfuscating the first node data by splitting the first node data into a plurality of data chunks and generating the protected form of the first node data by encrypting the data chunks by applying an encryption algorithm and swapping data between the chunks.

The method may include encrypting the data chunks prior to swapping data between the data chunks.

The method may include swapping data between the data chunks prior to encrypting the data chunks.

The method may further include establishing a hash value for the first node data, and determining, from the established hash value, at least one of data chunk size and data chunk number.

Applying the encryption algorithm may further include applying a symmetrical encryption algorithm.

Swapping data between the data chunks may further include using an XOR operation.

Swapping data between the data chunks may further include swapping a byte of a first data chunk with a byte of a second data chunk

The method may further include determining a hash value for each data chunk, and thereafter renaming each data chunk using the determined hash value of that data chunk.

Encrypting the data chunks further include employing a known portion of data from the first node data as an encryption key and/or encrypting each data chunk separately using known information from another of the data chunks as the encryption key.

The method may further include storing the protected form of first node data on a distributed network.

The method may further include recording identities of the protected data in one or more data maps for retrieving and/or validating authenticity of the protected form of the first node data.

Storing the protected form of first node data may further include determining whether one or more of the data chunks already exist on the distributed network and, storing the one or more data chunks only when the one or more of the data chunks do not already exist on the distributed network.

The method may further include using the protected data to represent financial or monetary value in a financial transaction system.

The first node data may include video conferencing data, audio teleconferencing data or both of these.

In another aspect, the present disclosure concerns a computer program product including a non-transitory computer-readable storage medium having computer-readable instructions stored thereon. The computer-readable instructions being executable by a processing hardware to cause one or more computers to obfuscate data of a first node data of a peer-to-peer network by splitting the first node data into a plurality of data chunks; and generate a protected form of the first node data by swapping data between the chunks and encrypting the data chunks by applying an encryption algorithm.

The instructions causing the one or more computers to generate a protected form of the first node data may further cause the one or more computers to encrypt the data chunks prior to swapping data between the data chunks.

The instructions causing the one or more computers to generate a protected form of the first node data further cause the one or more computers to swap data between the data chunks prior to encrypting the data chunks.

The instructions may further cause the one or more computers to establish a hash value for the first node data, and determine, from the established hash value, at least one of: data chunk size and data chunk number.

The instructions causing the one or more computers to apply the encryption algorithm may further cause the one or more computers to apply a symmetrical encryption algorithm.

The instructions which cause the one or more computers to swap data between the data chunks may further cause the one or more computers to employ an XOR operation.

The instructions may further cause the one or more computers to determine a hash value for each data chunk, and thereafter rename each data chunk using the determined hash value of that data chunk.

The instructions causing the one or more computers to encrypt the data chunks may further cause the one or more computers to employ a known portion of data from the first node data as an encryption key.

The instructions causing the one or more computers to employ the known information from another of the data chunks as the encryption key may further cause the one or more computers to encrypt each of the data chunks separately.

The instructions may further cause the one or more computers to store the protected form of first node data on a distributed network.

The instructions may further cause the one or more computers to record identities of the protected data in one or more data maps for retrieving and/or validating authenticity of the protected form of the first node data.

The instructions causing the one or more computers to store the protected form of first node data may further cause the one or more computers to determine whether one or more of the data chunks already exist on the distributed network and, store the one or more data chunks only when the one or more of the data chunks do not already exist on the distributed network.

In yet another aspect, the disclosure concerns a system for storing data of a first node on a peer-to-peer network in a protected form, which includes a file chunking module configured to split the first node data into a plurality of data chunks, a file encryption module arranged to encrypt the data chunks by applying an encryption algorithm and a file obfuscation module configured to swap data between the chunks.

In yet another aspect, the disclosure concerns an additional method of storing data from a first node on a peer-to-peer network. The method includes creating a public and private key pair from a data item, determining a hash value for the public key, assigning the hash value as a user identifier for the user of the nod. and storing the public key within a distributed hash table of the peer-to-peer network. The user identifier corresponds to the key for the public key within the distributed hash table.

The node may include a device capable of processing, communicating and storing information.

The node may include a personal computer.

The data item may include at least a first portion of information specific to the user.

A second portion of information specific to the user is never transmitted to the peer-to-peer network.

The method may include digitally signing the user identifier using the created private key, using the signed user identifier to authenticate access to the peer-to-peer network and using a second remote node to: receive the user identifier; retrieve a validation record associated with the user identifier within the distributed hash table of the peer-to-peer network; and transmit the retrieved validation record to the node.

The first node may be used to decrypt the validation record using the private key to obtain decrypted information and authenticate access to data on the peer-to-peer network using the decrypted information.

A second portion of information specific to the user may be used to decrypt the validation record wherein the decrypted information comprises an address on the peer-to-peer network for at least a first portion of the user data.

The method may include storing the user's data on a plurality of remote nodes and splitting the user data into a plurality of data chunks, wherein at least one chunk is stored on a different remote node from another of the at least one the chunks.

Each chunk may be encrypted before storage on the peer-to-peer network.

The users data may be obfuscated before storing on the network.

### BRIEF DESCRIPTION OF THE SEVERAL VIEWS OF THE DRAWINGS

Embodiments of the present disclosure will now be described, by way of example only, with reference to the accompanying drawings in which:

FIG. 1a is a system diagram according to an embodiment of the present disclosure;

FIG. 1b is a diagram of perpetual data elements of the system of FIG. 1a;

FIG. 1c is a diagram of self encryption elements of the system of FIG. 1a;

FIG. 1d is a diagram of datamap elements of the system of FIG. 1a;

FIG. 1e is a diagram of anonymous authentication elements of the system of FIG. 1a;

FIG. 1f is a diagram of shared access elements of the system of FIG. 1a;

FIG. 1g is a diagram of messenger elements of the system of FIG. 1a;

FIG. 1h is a diagram of cyber cash elements of the system of FIG. 1a;

FIG. 1i is a diagram of voting system elements of the system of FIG. 1a;

FIG. 2 is a flow chart of a self authentication process for the system of FIG. 1a;

FIG. 3 is a diagram of peer-to-peer interaction for the system of FIG. 1a;

FIG. 4 is a flow chart of an authentication process for the system of FIG. 1a;

FIG. 5 is a flow chart of a data assurance event for the system of FIG. 1a;

FIG. 6 is a flow chart of a chunking event for the system of FIG. 1a;

FIG. 7 is an example of chunking performed by the system of FIG. 1a;

FIG. 8 is a flow chart of a self healing event for the system of FIG. 1a;

FIG. 9 is a flow chart of a peer ranking event for the system of FIG. 1a;

FIG. 10 is a flow chart of a duplicate removal event for the system of FIG. 1a;

FIG. 11 is a flow chart for storing perpetual data performed by the system of FIG. 1a;

FIG. 12 is a diagram of a chunk checking process performed by the system of FIG. 1a;

FIG. 13 is a flow chart of the storage of additional chunks for the system of FIG. 1a;

FIG. 14 is a flow chart of a self healing process for the system of FIG. 1a;

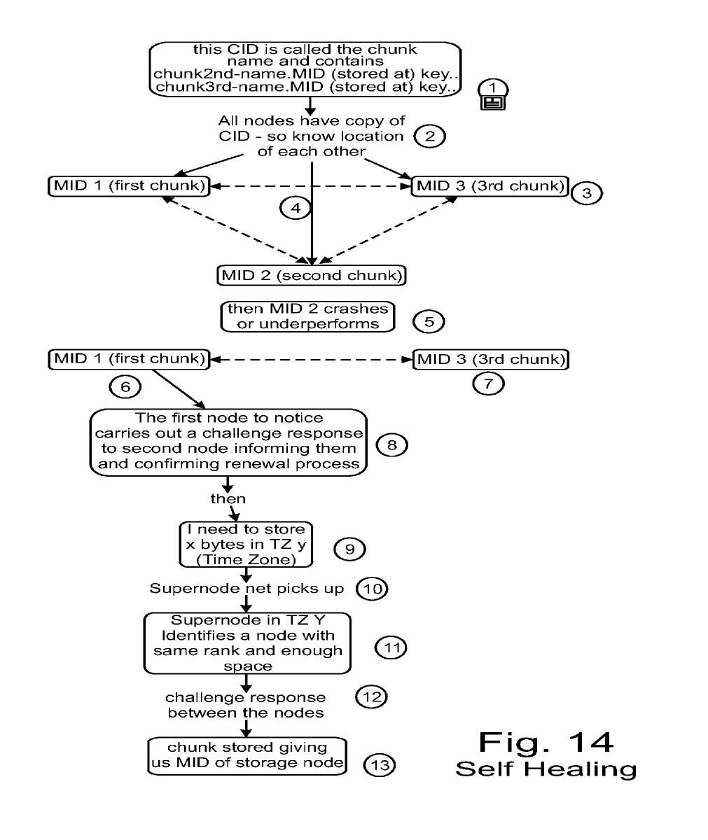

FIG. 15 is a flow chart of saving data for the system of FIG. 1a;

FIG. 16 is a flow chart of deleting data for the system of FIG. 1a;

FIG. 17 is a flow chart of a self encryption process of the system of FIG. 1a;

FIG. 18 is a flow chart of a shared access process of the system of FIG. 1a;

FIG. 19 is a flow chart of a messenger application for the system of FIG. 1a; and

FIG. 20 is a flow chart of a voting application for the system of FIG. 1a.

FIG. 21 is a schematic diagram of an example application of disclosed the systems, methods and computer program products for storing data of a first node on a peer-to-peer network in a protected form.

### DETAILED DESCRIPTION

An issue with today's networks is a combination of vendor lock in, imposed vendor based controls and lack of standards. The present invention allows users to take charge of a new global network in a manner that will maintain effectiveness and promote the setting and attaining of common goals.

Another issue with today's networks is the security and privacy of data; the present invention allows a secure private and free network, wherein users can enjoy an efficiently managed working environment that presents a guaranteed level of private and securely protected activity.

Many contemporary computer resources are underutilised to a great degree, including disk space, memory, processing power and any other attached resources; this is inefficient and environmentally detrimental. The present invention seeks to maximise these resources and share them globally to people who purchase them, or to people or organisations who are deemed appropriate to benefit from them, such as children in poorer countries, science labs and so forth. Allocation from these resource pools. together with other resources. will be decided by the users of the network. provided a distributed network system.

References are herewith made to abbreviations and identifications used to describe a system and its functionalities, pursuant to the present discloser, with reference to Table 4.

TABLE 4
Abbreviations and identifications

| Abbeviation | Explanation |
|---|---|
| MID | This is the base ID and is mainly used to store and forget |
| | files. Each of these store and forget operations will require |
| | a signed request. Restoring may simply require a request |
| | with an ID attached. |
| PMID | This is the proxy MID which is used to manage the |
| | receiving of instructions to the node from any network node |
| | such as get/put/forget and so forth. This is a key pair which |
| | is stored on the node; if stolen, the key pair can be |
| | regenerated simply disabling the thief's stolen PMID- |
| | although there is not much can be done with a PMID key |
| | pair. |
| CID | Chunk Identifier, which is simply the chunkid. KID |
| | message on the net. |
| TMID | This is today's ID, namely a one time ID as opposed to a |
| | one time password. This is to disguise further users and |
| | also ensure that their MID stays as secret as possible. |
| MPID | The SAFE public ID also referred to as the maidsafe.net |
| | public ID. This is the ID to which users associate their own |
| | name and actual data, if required. This is the ID for |
| | messenger, sharing, non-anonymous voting and any other |
| | method that requires that the user be known. |
| MAID | This is basically the hash of and actual public key of the |
| | MID. this ID is used to identify the user actions such as |
| | put/forget/get on the SAFE network also referred to as the |
| | maidsafe.net network. This allows a distributed PKI |
| | infrastructure to exist and be automatically checked. |
| KID | Kademlia ID: this can be randomly generated or derived |
| | from known and preferably anonymous information such as |
| | an anonymous public key hash as with the MAID. In this |
| | case, Kademlia is used as an example overlay network, |
| | although this can be almost any network environment at all. |
| MSID | SAFE Share ID also referred to as Maidsafe.net Share ID: |
| | an ID and key pair specifically created for each share to |
| | allow users to interact with shares using a unique key not |
| | related to their MID which should always be anonymous |
| | and separate. |

Anonymous authentication relates to system authentication and, in particular, authentication of users for accessing resources stored on a distributed or peer-to-peer (P2P) file system. Its aim is to preserve the anonymity of the users and to provide secure and private storage of data and shared resources for users on a distributed system. It is a method of authenticating access to a distributed system comprising steps of:
I. Receiving a user identifier;
II. Retrieving an encrypted validation record identified by the user identifier;
III. Decrypting the encrypted validation record so as to provide decrypted information; and
IV. Authenticating access to data in the distributed system using the decrypted information.

As will be described later in greater, such a method is beneficially employed for implementing cyber currency (for example “Bitcoin”) financial transaction systems, voting systems, high security telephonic systems, high security video conferencing systems, high security surveillance systems, high security robust data storage, but not limited to such applications.

Receiving, retrieving and authenticating may be performed on a node in a distributed system pursuant to the present disclosure, preferably separately from a node performing the step (iii) of decrypting. The method further optionally comprises a step of generating the user identifier using a hash. Therefore, the user identifier may be considered unique, and optionally altered if a collision occurs, and suitable for identifying unique validation records. The step (iv) of authenticating access may preferably further comprise a step of digitally signing the user identifier. This provides authentication that can be validated against trusted authorities. The method further comprises a step of using the signed user identifier as a session passport to authenticate a plurality of accesses to the distributed system. This allows persistence of the authentication for an extended session.

The step (iii) of decrypting preferably comprises decrypting an address in the distributed system of a first chunk of data and the step of authenticating access (iv) further comprises a step of determining the existence of the first chunk at the address, or providing the location and names of specific data elements in the network in the form of a data map as previously described. Such an approach efficiently combines the tasks of authentication and starting to retrieve the data from the system. The method preferably further comprises a step of using the content of the first chunk to obtain further chunks from the distributed system. Additionally the decrypted data from the additional chunks may contain a key pair allowing the user at that stage to sign a packet sent to the network to validate them or additionally may preferable self sign their own identification (ID).

Therefore, there is no need to have a potentially vulnerable record of the file structure persisting in one place on the distributed system pursuant to the present disclosure, as the user's node constructs its database of file locations after logging onto the system.

There is provided a distributed system comprising:
I. a storage module adapted to store an encrypted validation record;
II. a client node comprising a decryption module adapted to decrypt an encrypted validation record so as to provide decrypted information; and
III. a verifying node comprising:
IV. a receiving module adapted to receive a user identifier;
V. a retrieving module adapted to retrieve from the storage module an encrypted validation record identified by the user identifier;
VI. a transmitting module adapted to transmit the encrypted validation record to the client node; and
VII. an authentication module adapted to authenticate access to data in the distributed file system using the decrypted information from the client node.

The client node is further adapted to generate the user identifier using a hash. The authentication module is further adapted to authenticate access by digitally signing the user identifier. The signed user identifier is used as a session passport to authenticate a plurality of accesses by the client node to the distributed system. The decryption module is further adapted to decrypt an address in the distributed system of a first chunk of data from the validation record, and the authentication module is further adapted to authenticate access by determining the existence of the first chunk at the address. The client node is further adapted to use the content of the first chunk to obtain further authentication chunks from the distributed system.

There is provided at least one computer program comprising program instructions for causing at least one computer to perform. One computer program is embodied on a non-transitory (non-transient) machine-readable recording medium or read-only memory, stored in at least one computer memory, or carried on an electrical carrier signal.

Additionally, there is a check on the system to ensure the user is logged into a valid node, namely a valid software package; such a check assists to avoid malware obtaining sensitive user login codes. This will preferably include the ability of the system to check validity of the running SAFE software also referred to as maidsafe.net software by running content hashing or preferably certificate checking of the node and also the code itself.

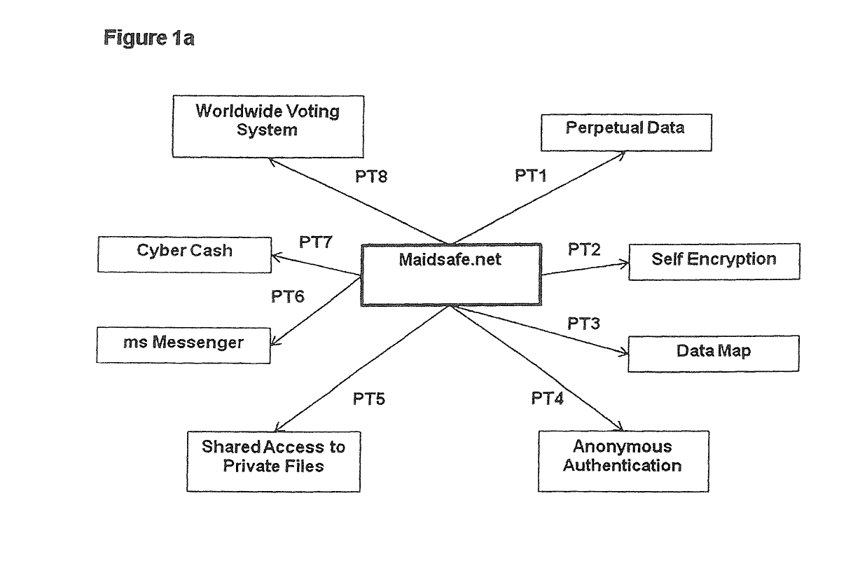

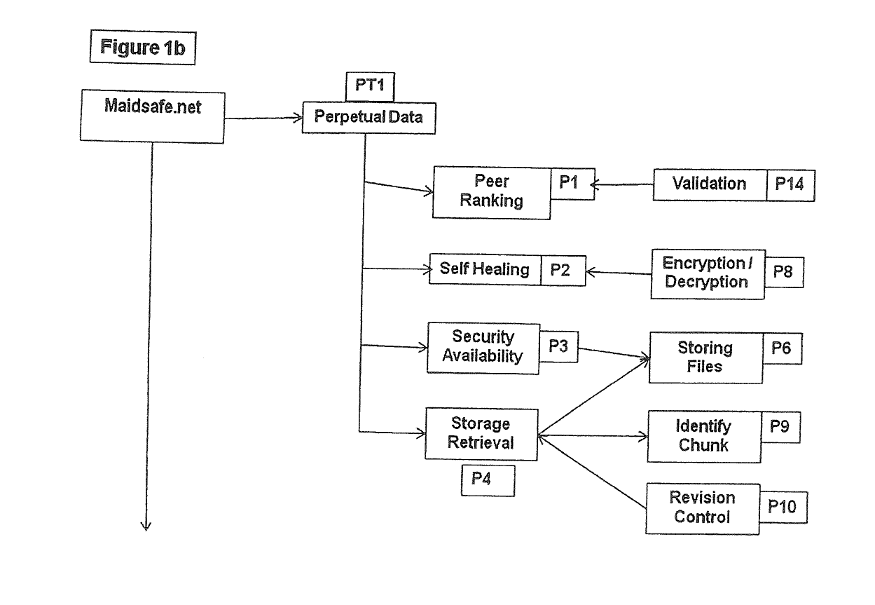

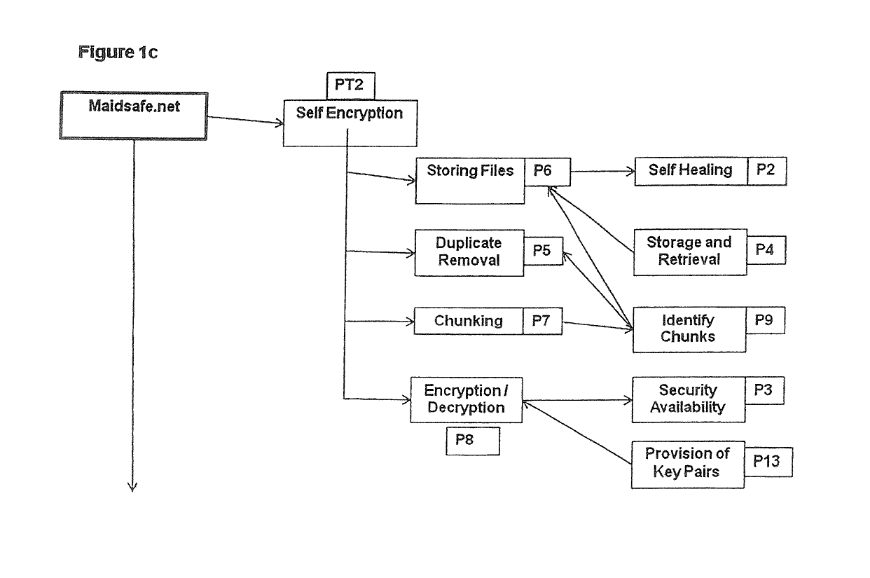

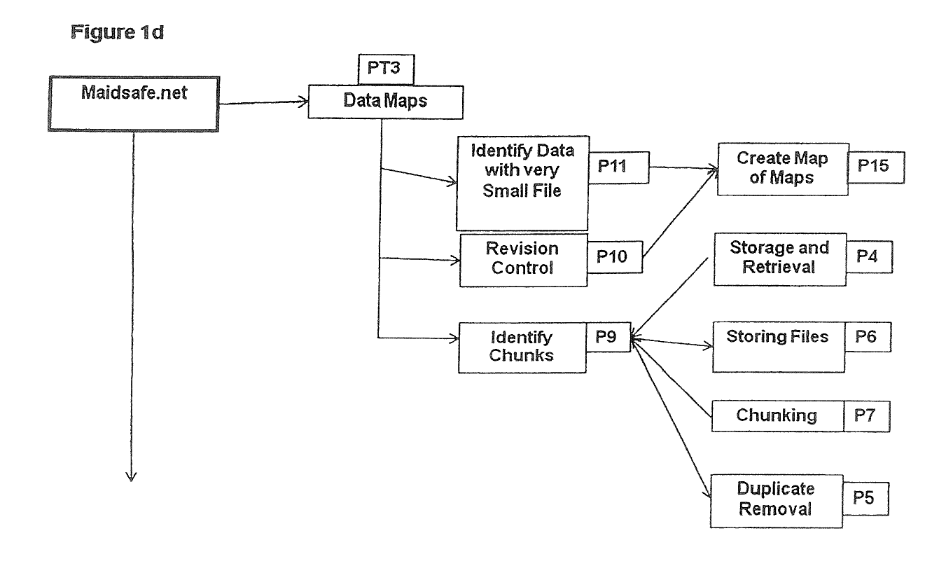

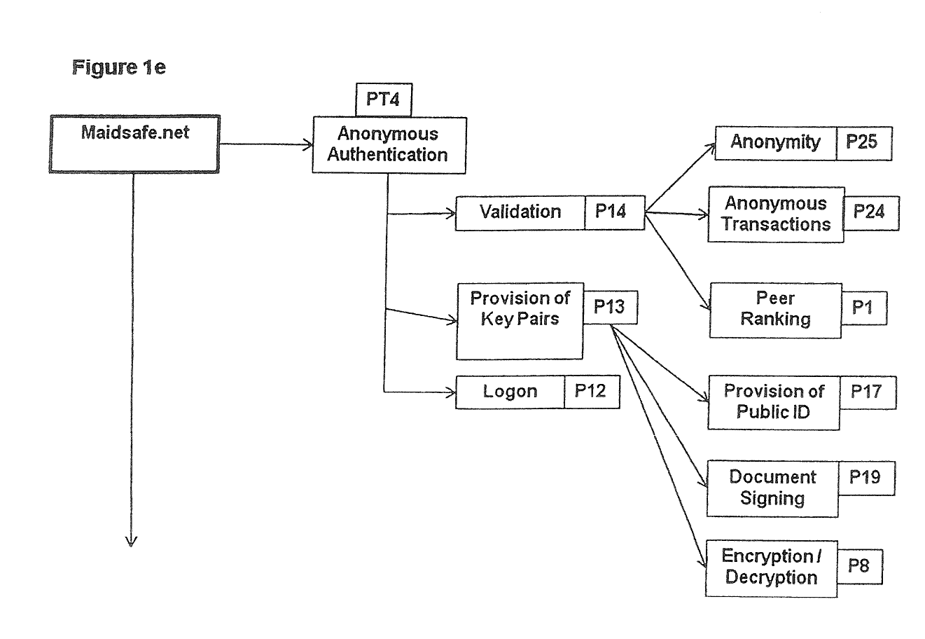

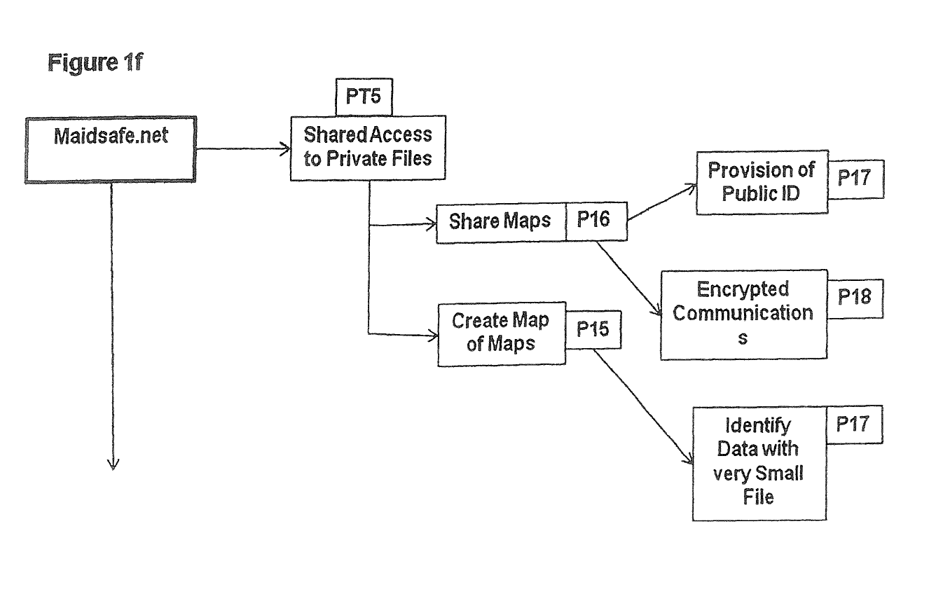

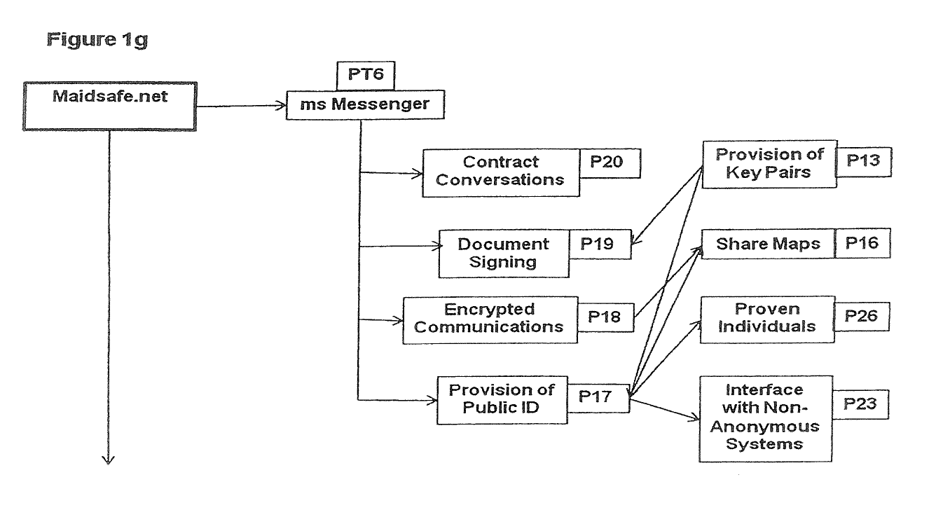

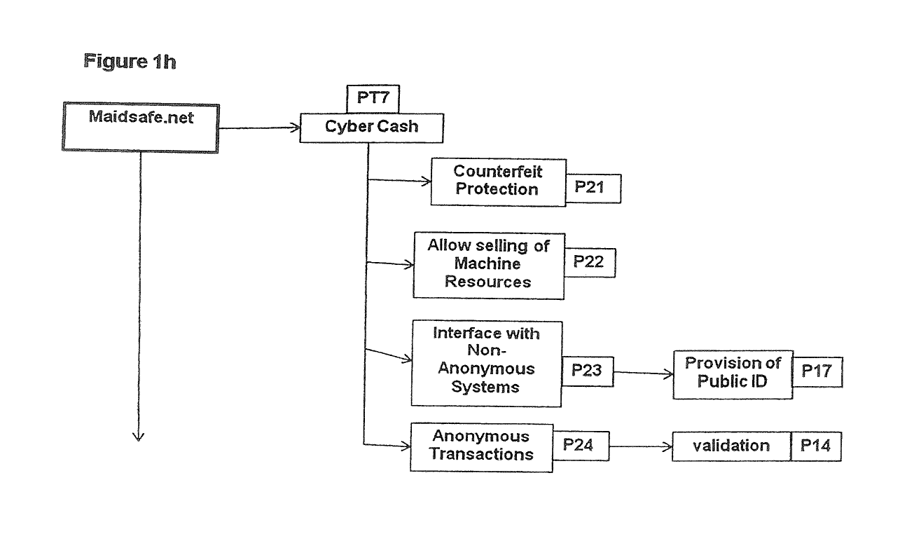

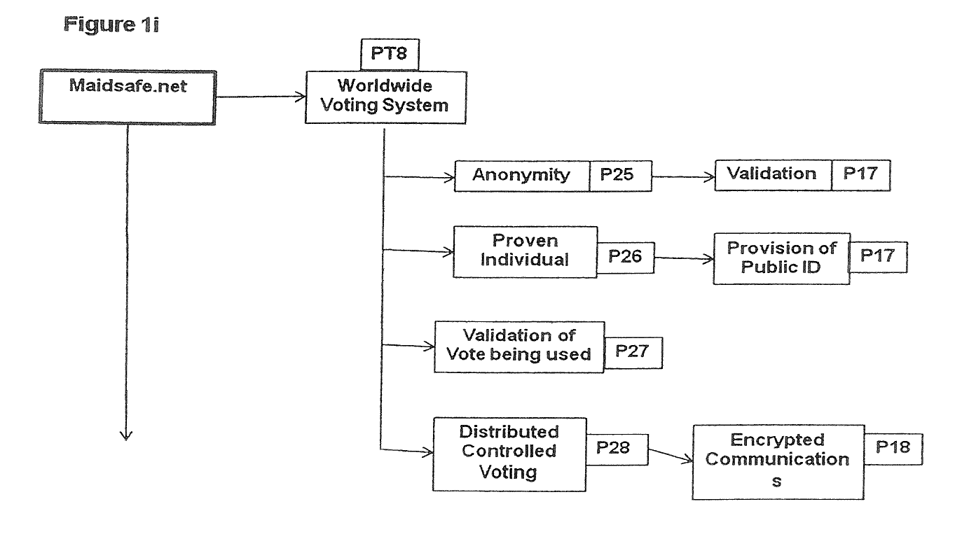

Referring to FIG. 1, there is shown an illustration of linked elements for the SAFE system also referred to as the maidsafe.net system, The system has eight individual principal elements denoted by PT1 to PT8, which collectively have twenty eight inter-linked functional elements denoted by P1 to P28, wherein PTx and Py are further elucidated in Table 5 and Table 6:

TABLE 5
Principal elements of the maidsafe.net system

| Principal | |
|---|---|
| element | Detail |
| PT1 | Perpetual Data |
| PT2 | Self encryption |
| PT3 | Data Maps |
| PT4 | Anonymous Authentication |
| PT5 | Shared access to Private files |
| PT6 | ms Messenger |
| PT7 | Cyber Cash |
| PT8 | Worldwide Voting System |

TABLE 6
Inter-linked functional elements of the maidsafe.net system

| Function | |
|---|---|
| element | Detail |
| P1 | Peer Ranking |
| P2 | Self Healing |
| P3 | Security Availability |
| P4 | Storage and Retrieval |
| P5 | Duplicate Removal |
| P6 | Storing Files |
| P7 | Chunking |
| P8 | Encryption/Decryption |
| P9 | Identify Chunks |
| P10 | Revision Control |
| P11 | Identify Data with Very Small File |
| P12 | Logon |
| P13 | Provide Key Pairs |
| P14 | Validation |
| P15 | Create Map of Maps |
| P16 | Share Map |
| P17 | Provide Public ID |
| P18 | Encrypted Communications |
| P19 | Document Signing |
| P21 | Counterfeit Prevention |
| P22 | Allow Selling of Machine Resources |
| P23 | Interface with Non-Anonymous Systems |
| P24 | Anonymous Transactions |
| P25 | Anonymity |
| P26 | Proven Individual |
| P27 | Validation of Vote Being Used |
| P28 | Distributed Controlled Voting |

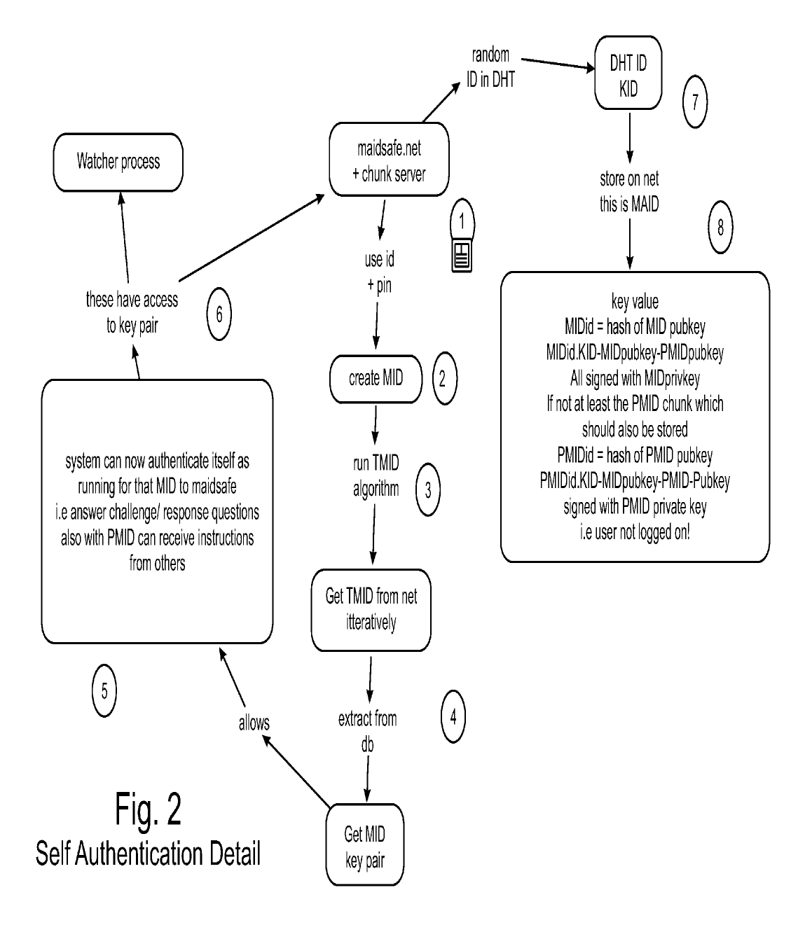

Next, with reference to FIG. 2, self authentication will described in greater detail.

1. A computer program consisting of a user interface and a chunk server, namely a system to process anonymous chunks of data, is running, if not the computer program is started when an associated given user selects an icon or other means of starting the computer program.

2. The given user inputs some data known to him/her, such as a user ID (random ID), and PIN number in this case. These pieces of information, namely the user ID and the PIN number, are optionally concatenated together and hashed to create a unique identifier, which is optionally confirmed via a search. In such case, this is called the MID (“SAFE Id” or “maidsafe.net ID”).

3. A TMID (Today's MID) is retrieved from the maidsafe.net network, wherein the TMID is then calculated as follows:

The TMID is a single-use or single-day ID that is constantly changed. This TMID allows SAFE also referred to as maidsafe.net to calculate the hash based on the user ID pin and another known variable which is calculable. For this variable, it is beneficial to employ a day variable, for example, and this is the number of days since epoch (for example Jan. 1, 1970). This allows for a new ID daily, which assists in maintaining the anonymity of the given user. This TMID will create a temporary key pair to sign database (db) chunks and accept a challenge response from an associated holder of these db chunks. After retrieval and generation of a new key pair, the db is put again in new locations, rendering everything that was contained in the TMID chunk useless. The TMID CANNOT be signed by anyone, therefore hackers cannot BAN an unsigned user from retrieving this, for example in a DOS attack; it is a special chunk where the data hash does NOT match the name of the chunk, as the name is a random number calculated by hashing other information, namely it is a hash of the TMID as described below:

STEP 1: take dave as user ID and 1267 as pin.

STEP 2: dave+(pin) 1267=dave1267. A hash of this becomes the

MID.

STEP 3; day variable (say today is 13416 since epoch)=13416. So take pin, and for example add the number in where the pin states, namely 613dav41e1267 (6 at beginning is going around the pin again) so this is done by taking 1^{st} pin 1, so put first day value at position 1

STEP 4: then next pin number 2, so day value 2 at position 2.

STEP 5: then next pin number 6 so day value 3 at position 6.

STEP 6: then next pin number 7 so day value 4 at position 7.

STEP 7: then next pin number is 1 so day value 5 at position 1 (again) so TMID is a hash of 613dav41e1267, and the MID is simply a hash of dave 1267. This is an example algorithm in STEP1 to STEP 7, and many more can be used to enforce further associated security.

4. From the TMID chunk, the map of the users database, or list of files maps, is identified. The database is recovered from the maidsafe.net network, which includes the data maps for the user and any keys passwords, and so forth. The database chunks are stored in another location immediately, and the old chunks forgotten. This can be done now as the MID key pair is also in the database and can now be used to manipulate the given users data.

5. The SAFE application also referred to as the maidsafe.net application can now authenticate itself as acting for this MID and put get or forget data chunks belonging to the given user.

6. A watcher process and a chunk server always have access to the PMID key pair as they are stored on the machine itself, so they can start and receive and authenticate anonymous put/get/forget commands.

7. A DHT ID is required for a node in a DHT network this may be randomly generated or in fact we can use the hash of the PMID public key to identify the node.

8. When the user is successfully logged in, he/she can check whether or not his/her authentication validation records exist on the maidsafe.net network. These may be as follows in MAID (SAFE or maidsafe.net anonymous ID):

STEP 1: This is a data element stored on the maidsafe.net network and preferably named with the hash of the MID public key.

STEP 2: It contains the MID public key+any PMID public keys associated with this given user.

STEP 3: This is digitally signed with the MID private key to prevent forgery.

STEP 4: Using such a mechanism, this allows validation of MID signatures by allowing any users access to this data element and checking the signature of it against any challenge response from any node pertaining to be this MID, as only the MID owner has the private key that signs this MID. Any crook could not create the private key to match to the public key to digitally sign, so forgery is made impossible given today's computer resources.

STEP 5: This mechanism also allows a user to add or remove PMIDS (or chunk servers acting on their behalf like a proxy) at will and replace PMID's at any time in case of the PMID machine becoming compromised. Therefore, this can be considered to be the PMID authentication element.

Next, PMID (Proxy MID) will be elucidated in greater detail.

STEP 1: This PMID is a data element stored on the maidsafe.net network and preferably named with the hash of the PMID public key.

STEP 2: It contains the PMID public key and the MID ID, namely the hash of the MID public key, and is signed by the MID private key, namely is authenticated.

STEP 3: This allows a machine to act as a repository for anonymous chunks and supply resources to the net for a MID.

STEP 4: When answering challenge responses, any other machine will confirm the PMID by seeking and checking the MIAD for the PMID and making sure the PMID is mentioned in the MAID bit, otherwise the PMID is considered “rouge”, namely false or a forgery.

STEP 5. The key pair is stored on the machine itself, and is optionally encoded or encrypted against a password that has to be entered upon start-up, for example optionally in the case of a proxy provider who wishes to enhance PMID security further.

STEP 6: The design allows for recovery from attack and theft of the PMID key pair as the MAID data element can simply remove the PMID ID from the MAID rendering it unauthenticated.

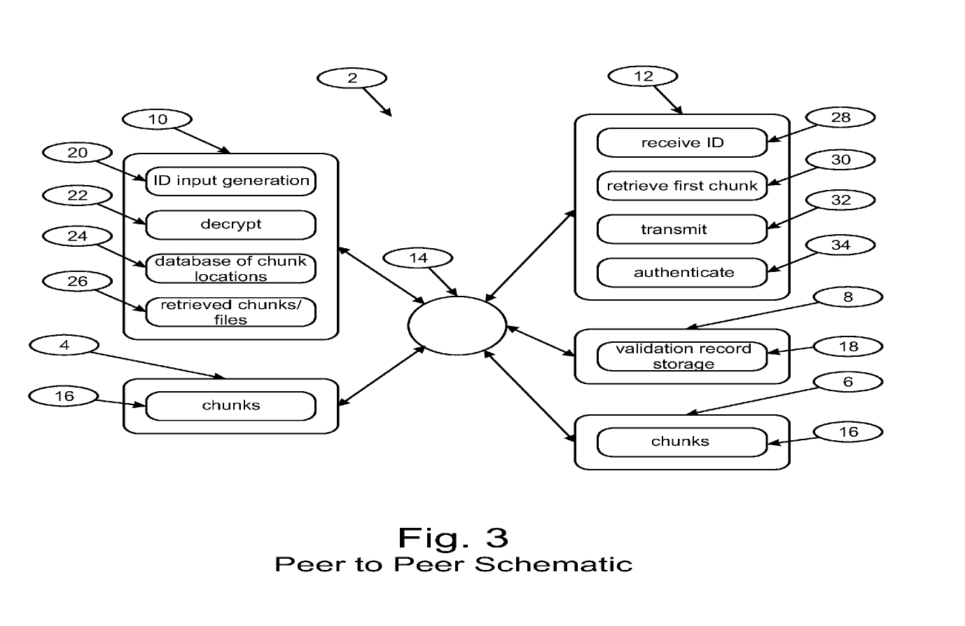

In FIG. 3, there is shown an illustration, in schematic form, of a peer-to-peer (P2P) network in accordance with an embodiment of the present disclosure; and

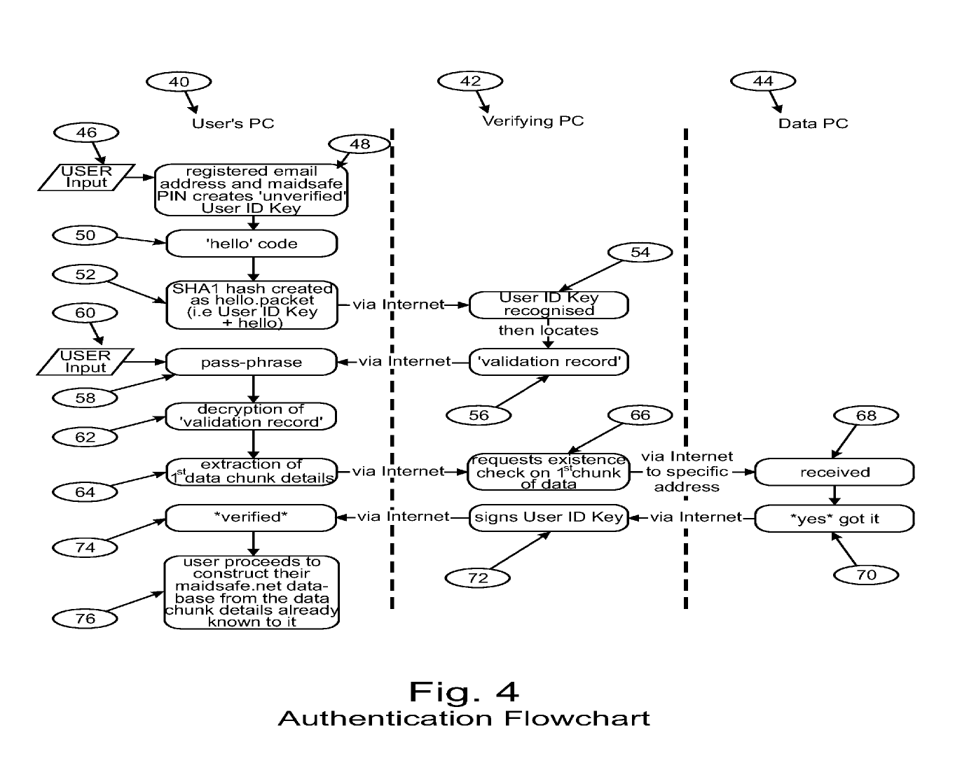

In FIG. 4, there is shown an illustrates of a flow chart of the authentication, in accordance with a preferred embodiment of the present disclosure.

With reference to FIG. 3, a peer-to-peer (P2P) network 2 is shown with nodes 4 to 12 mutually connected via a communication network 14. The nodes 4 to 12 may be personal computers (PCs), or any other device that can perform the processing, communication and/or storage operations required to operate embodiments of the present disclosure. There is employed a file system which will typically have many more nodes of all types than shown in FIG. 3, and a PC may act as one or many types of node described herein. The data nodes 4 and 6 store chunks 16 of files in the distributed maidsafe.net system. The validation record node 8 has a storage module 18 for storing encrypted validation records identified by a user identifier.

The client node 10 has a module 20 for input and generation of user identifiers. It also has a decryption module 22 for decrypting an encrypted validation record, so as to provide decrypted information, a database or data map of chunk locations 24 and storage 26 for retrieved chunks and files assembled from the retrieved chunks.

The verifying node 12 has a receiving module 28 for receiving a user identifier from the client node. The retrieving module 30 is configured to retrieve from the data node an encrypted validation record identified by the user identifier. Alternatively, in the preferred embodiment, the validation record node 8 is the same node as the verifying node 12, name it the storage module 18 is part of the verifying node 12, namely not as shown in FIG. 3. A transmitting module 32 sends the encrypted validation record to the client node. A authentication module 34 authenticates access to chunks of data distributed across the data nodes using the decrypted information.

With reference to FIG. 4, a more detailed flow chart of the operations of embodiments of the present disclosure is shown laid out on the diagram with associated steps being performed at the given user's PC, namely client node, on a left-hand side 40, those of the verifying PC, namely node, in a centre region 42 and those of the data PC, namely node, on a right-hand side 44.

A login box is presented, as denoted by 46, that requires the given users name or other detail, preferably email address (namely the same one used in the client node software installation and registration process) or simply a convenient name (for example a nickname) and the given user's unique number, preferably PIN number. If the given user is a ‘main user’, then some details may already be stored on the PC. If the given user is a visitor, then the login box 46 appears.

A content hashed number such as SHA (Secure Hash Algorithm), preferably 160 bits in length, is created, as denoted by 48, from these two items of data. This ‘hash’ is now known as the ‘User ID Key’ (MID), which at this point is classed as ‘unverified’ within the maidsafe.net system. This is stored on the maidsafe.net network as the MAID and is simply the hash of the public key containing an unencrypted version of the public key for later validation by any other node. This obviates a requirement for a validation authority, namely avoids a need for any central server facility, making the maidsafe.net system a truly distributed system. The software on the given users PC then combines this MID with a standard ‘hello’ code element as denoted 50, to create a ‘hello. packet’ as denoted by 52. This hello.packet is then transmitted with a timed validity on the Internet.

The hello.packet will be picked up by the first node, for this description, now called the ‘verifying node’, that recognises 54 the User ID Key element of the hello.packet as matching a stored, encrypted validation record file 56 that it has in its storage area. A login attempt monitoring system ensures a maximum of three responses. Upon too many attempts, the verifying PC creates a ‘black list’ for transmission to peers. Optionally, an alert is returned to the user, if a ‘black list’ entry is found, and the user may be asked to proceed or perform a virus check.

The verifying node then returns this encrypted validation record file to the user via the Internet. The user's pass phrase 58 is requested by a dialog box 60, which then will allow decryption of this validation record file.

When the validation record file is decrypted 62, the first data chunk details, including a ‘decrypted address’, are extracted 64 and the given user PC sends back a request 66 to the verifying node for it to initiate a query for the first ‘file-chunk ID’ at the ‘decrypted address’ that it has extracted from the decrypted validation record file, or preferably the data map of the database chunks to recreate the database and provide access to the key pair associated with this MID.

The verifying node then acts as a ‘relay node’ and initiates a ‘notify only query for this ‘file-chunk ID’ at the ‘decrypted address’.

Given that some other node, for this embodiment, called the ‘data node’, has recognised 68 this request and has sent back a valid ‘notification only’ message 70 that a ‘file-chunk ID’ corresponding to the request sent by the verifying node does indeed exist, the verifying node then digitally signs 72 the initial User ID Key, which is then sent back to the user. On reception by the user 74, this verified User ID Key is used as the user's session passport. The users PC proceeds to construct 76 the database of the file system as backed up by the user onto the maidsafe.net network. This database describes the location of all chunks that make up the user's file system. Preferably, the ID Key will contain irrefutable evidence such as a public/private key pair to allow signing onto the network as authorised users; preferably, this is a case of self signing his/her own ID—in which case the ID Key is decrypted and user is valid, namely self validating.

Further details of the embodiment will now be described. A ‘proxy-controlled’ handshake routine is employed through an encrypted point-to-point channel, to ensure only authorised access by the legal owner to the system, then to the user's file storage database, then to the files therein. The handshaking check is initiated from the PC onto which a user logs onto, namely the ‘User PC”, by generating the ‘unverified encrypted hash’ known as the ‘User ID Key’, this ‘User ID Key’ is preferably created from the users information, preferably the user's e-mail address and his/her PIN number. This ‘hash’ is transmitted as a ‘hello. packet’ on the Internet, to be picked up by any system that recognises the User ID as being associated with specific data that it holds. This PC then becomes the “verifying PC” and will initially act as the User PC's ‘gateway’ into the maidsafe.net system during the authentication process. The encrypted item of data held by the verifying PC will temporarily be used as a ‘validation record’, it being directly associated with the user's identity and holding the specific address of a number of data chunks belonging to the user and which are located elsewhere in the peer-to-peer (P2P) distributed file system of the maidsafe.net network. This ‘validation record’ is returned to the User PC for decryption, with the expectation that only the legal user can supply the specific information that will allow its accurate decryption. Preferably, this data is optionally a signed response being given back to the validating node, which is possible as the ID chunk when decrypted, preferably by employing symmetrical decryption, contains the user's public and private keys, allowing non-refutable signing of data packets.

Preferably, after successful decryption of the TMID packet, as described above. the machine will now have access to the data map of the database and public/private key pair allowing unfettered access to the maidsafe.net system.

It will be appreciated that, in this embodiment, preferably communication is not carried out via any nodes without an encrypted channel such as TLS (Transport Layer Security) or SSL (Secure Sockets Layer) being set up first. A peer talks to another peer via an encrypted channel and the other peer (proxy) requests the information, for example for some space to save information on or for the retrieval of a file. An encrypted link is formed between all peers at each end of communications, and also through the proxy during the authentication process. This effectively bans snoopers from detecting who is talking to whom and also what is being sent or retrieved. The initial handshake for self authentication is also over an encrypted link.

Secure connection is provided via certificate passing nodes, in a manner that does not require intervention, with each node being validated by another, where any invalid event or data, for whatever reason (for example fraud detection, snooping from node or any invalid algorithms that catch the node) will invalidate the chain created by the node. This is all transparent to the user.

Further modifications and improvements may be added without departing from the scope of the invention herein described.

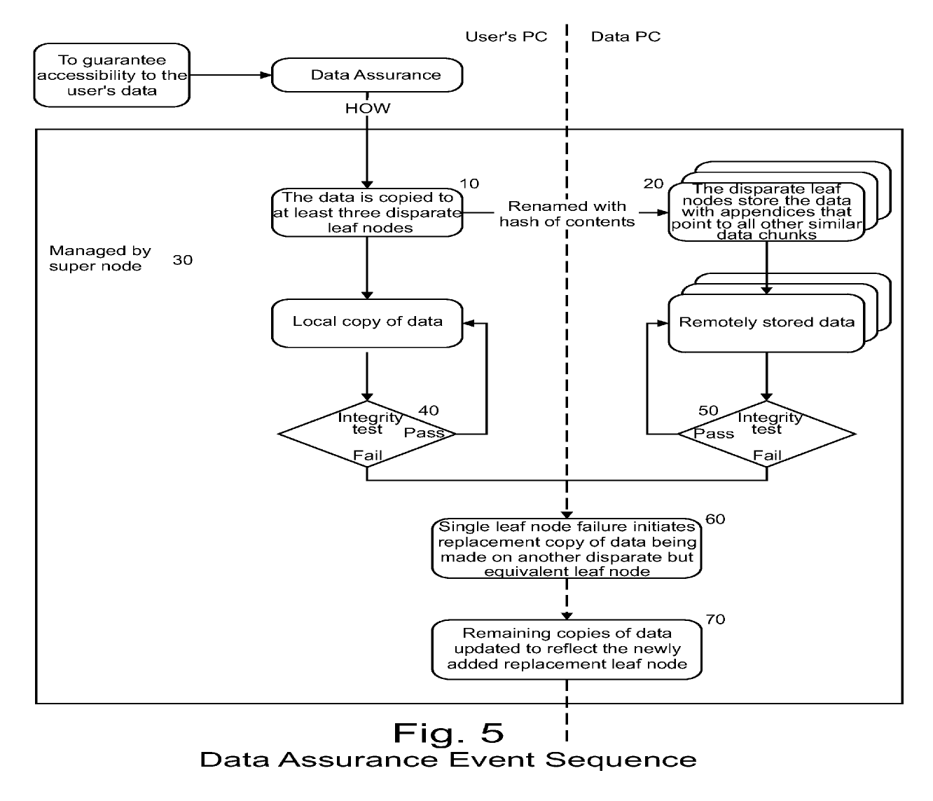

In FIG. 5, there is an illustration of a flow chart of a data assurance event sequence in accordance with first embodiment of the present disclosure.

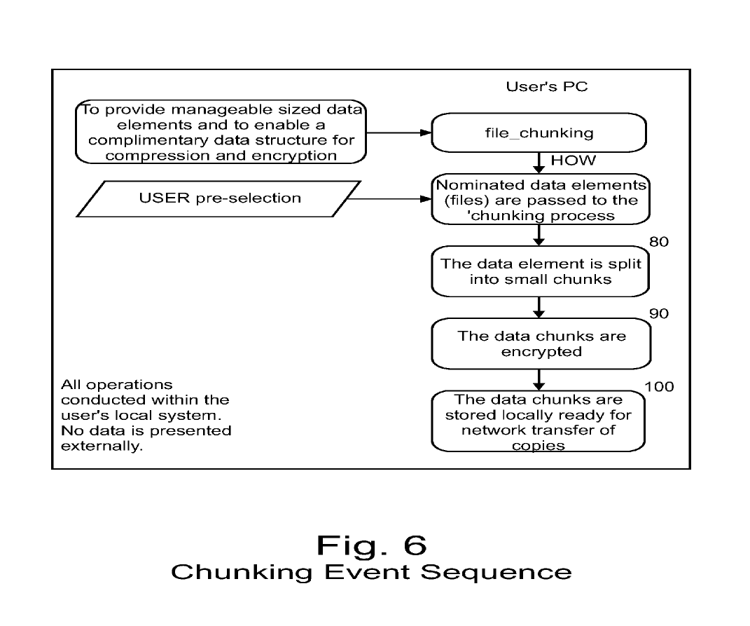

In FIG. 6, there is an illustration of a flow chart of a file chunking event sequence in accordance with second embodiment of the present disclosure.

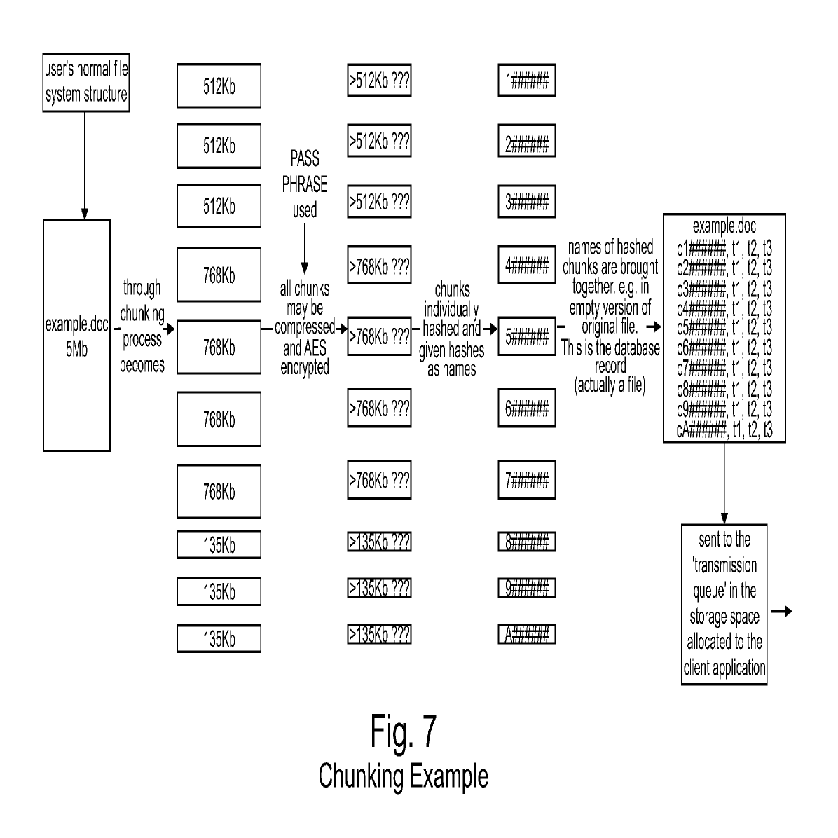

In FIG. 7, there is an illustration of a schematic diagram of a file chunking example.

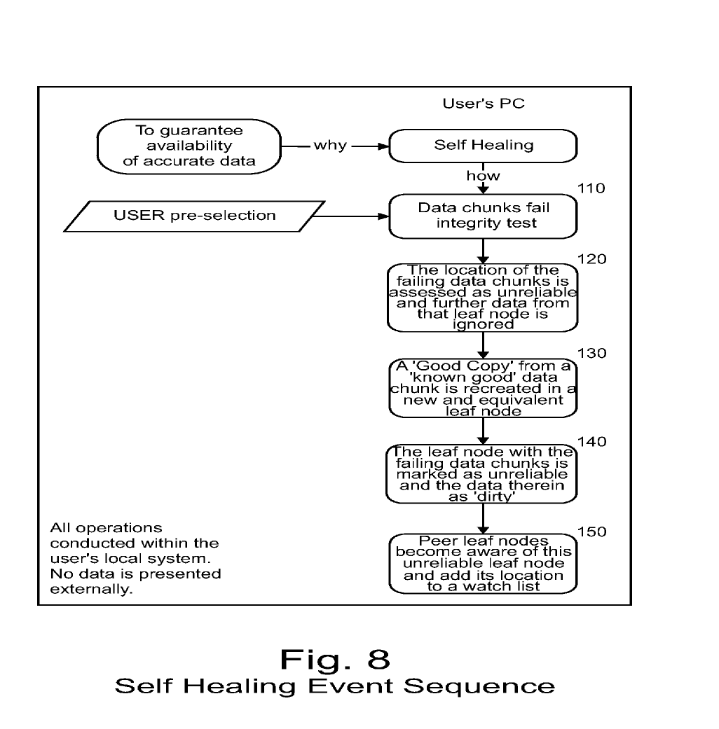

In FIG. 8, there is an illustration of a flow chart of a self healing event sequence.

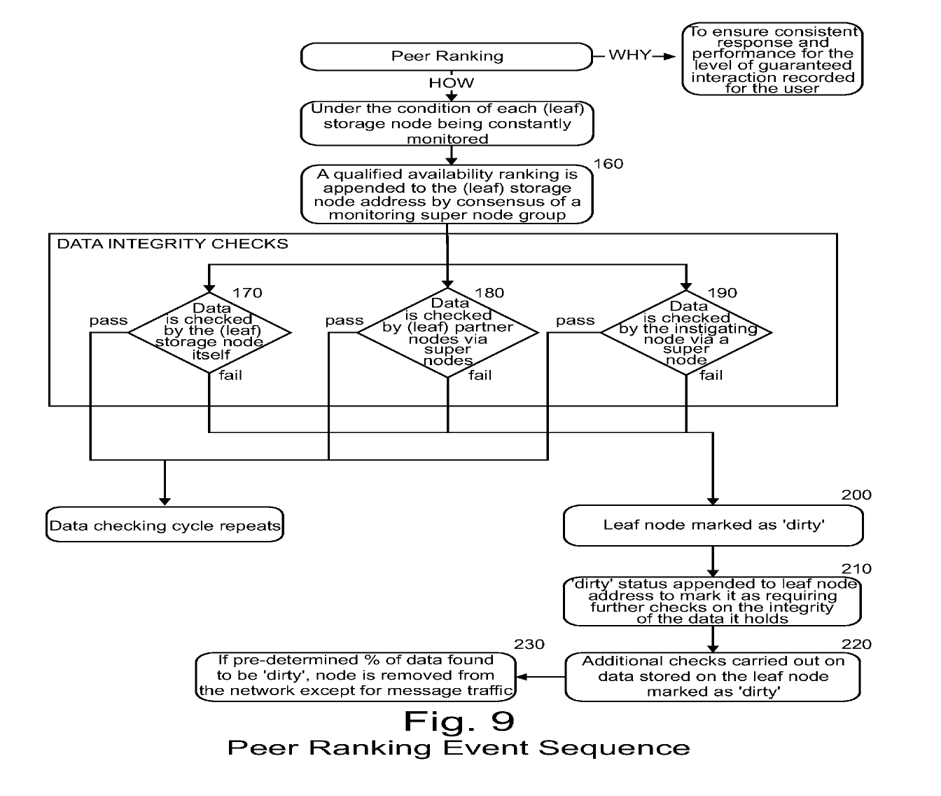

In FIG. 9, there is an illustration of a flow chart of a peer ranking event sequence.

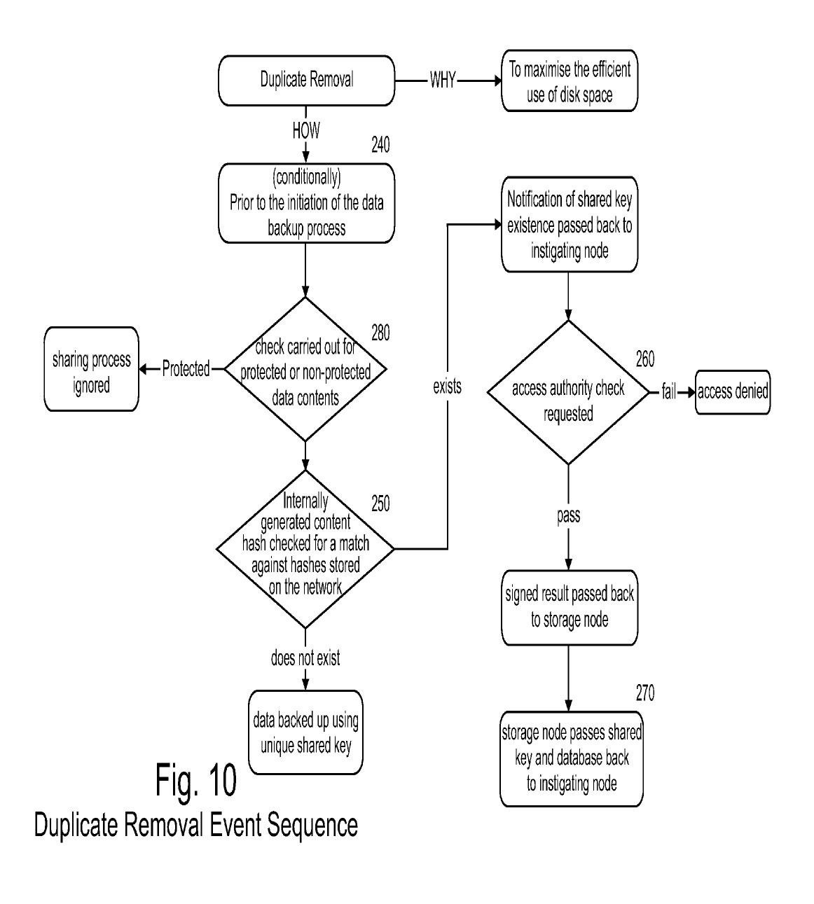

In FIG. 10, there is an illustration of a flow chart of a duplicate removal event sequence.

With reference to FIG. 5, guaranteed accessibility to user data by data assurance is demonstrated by a flow chart. The data is copied to at least three disparate locations at a step 10. The disparate locations store data with an appendix pointing to the other two locations by a step 20, and is renamed with a hash of contents. Preferably, such an action is managed by another node, namely a supernode acting as an intermediary by a step 30.

Each local copy at user's PC is checked for validity by an integrity test in a step 40, and in addition validity checks by an integrity test are made that the other two copies are also still OK by a step 50.

Any single node failure initiates a replacement copy of equivalent leaf node being made in another disparate location by a step 60, and the other remaining copies are updated to reflect this change to reflect the newly added replacement leaf node by a step 70.

The steps of storing and retrieving are carried out via other network nodes to mask the initiator 30.

The method further comprises a step of renaming all files with a hash of their contents.

Therefore, each file can be checked for validity or tampering by running a content hashing algorithm such as, for example, MD5 or an SHA variant, wherein the result of this is compared with the name of the file.

With reference to FIG. 6, there is provided a methodology to provide manageable sized data elements, and to enable a complimentary data structure for compression and encryption to be achieved, namely the step is to file chunking. By the user's pre-selection, the nominated data elements, for example files, are passed to a chunking process. Each data element, for example file, is split into small chunks by a step 80, and the data chunks are encrypted by a step 90, to provide security for the data. The data chunks are stored locally at a step 100, namely ready for network transfer of copies. Only a person or a group, to whom the overall data belongs, will know the location of these in the step 100, or the other related but dissimilar chunks of data. All operations are conducted within the user's local system. No data is presented externally. However, optionally, as will be elucidated in greater detail later, metadata is optionally generated at the user's PC which is made available for data aggregation purposes, for example targeted advertising. However, there is beneficially provided a software mechanism on the user's PC, which enables the user to select a degree of data security that the user desires, for example complete secrecy or privacy, or only partial privacy. For example, there are provided one or more user-settable threshold parameters which control generation of such metadata. Such aggregation of metadata can be used by an operator of the meadsafe.net network for targeted advertising purposes, thereby providing advertising funds for paying for maintenance of the maidsafe.net system.

Each of the above chunks does not contain location information for any other dissimilar chunks. This provides for, security of data content, a basis for integrity checking and redundancy.

The method further comprises a step of allowing only the person, or group, to whom the data belongs, to have access to it, preferably via a shared encryption technique. This allows for persistence of data.

The checking of data or chunks of data between machines is beneficial carried out via any presence type protocol, such as a distributed hash table network.

On an occasion when all data chunks have been relocated, namely the user has not logged on for a while, a redirection record is created and stored in the supernode network; there is thereby provided a three-copy process, namely similar to data. Therefore, when a user requests a check, the redirection record is given to the user to update his/her database.

This efficiently allows data resilience in cases where network churn, namely available data processing and communication capacity of the network, is a problem, as in peer-to-peer (P2P) networks or other types of distributed networks.

With reference to FIG. 7, which is an illustration of a flow chart example of file chunking, a user's normal file is a 5 Mbyte document, which is chunked into smaller variable sizes, for example to data chunks having a size of 135 kbytes, 512 kbytes, 768 kbtyes in any order. All data chunks are beneficially compressed and encrypted by using a Pass phrase. A next step is to hash data chunks individually, and to give hashes as their names. Then, a database record as a file is made from names of hashed chunks brought together, for example in an empty version of an original file (C1########,t1,t2,t3: C2########,t1,t2,t3 and so forth); this file is then sent to a transmission queue in storage space allocated to a client application.

With reference to FIG. 8, there is provided a self-healing event sequence methodology. Self-healing is required to guarantee availability of accurate data. As data or data chunks become invalid by failing integrity test by a step 110, the location of failing data chunks is assessed as unreliable and further data from the leaf node is ignored from that location by a step 120. A ‘Good Copy’ from the ‘known good’ data chunk is recreated in a new and equivalent leaf node. Data or chunks are recreated in a new and safer location by a step 130. The leaf node with failing data chunks is marked as unreliable and the data therein as ‘dirty’ by a step 140. Peer leaf nodes become aware of this unreliable leaf node and add its location to watch list by a step 150. All operations are all beneficially conducted within the users local system. No data is beneficially presented externally, to maintain secrecy and anonymity, unless overridden by deliberate user choice.

Therefore, the introduction of viruses, worms and so forth will be prevented and faulty machines/equipment identified automatically.

The maidsafe.net network beneficially employs SSL- or TLS-type encryption to prevent unauthorized access or snooping.

With reference to FIG. 9, Peer Ranking ID is required to ensure consistent response and performance for the level of guaranteed interaction recorded for the user. For Peer Ranking, each node (leaf node) monitors its own peer node's resources and availability in a scalable manner; thereby, each leaf node is constantly monitored.

Each data store (whether a network service, physical drive and so forth) is monitored for availability in the maidsafe.net system. A qualified availability ranking is appended to the (leaf) storage node address by consensus of a monitoring super node group by a step 160. A ranking figure will be appended by a step 160, and signed by the supply of a key from the monitoring supernode; this is preferably agreed by more supernodes to establish a consensus for altering the ranking of the node. The new rank is preferably appended to the node address, or by a similar mechanism to allow the node to be managed preferably in terms of what is stored there and how many copies there has to be of the data for it to be seen as perpetual.

Each piece of data is checked via a content hashing mechanism for data integrity, which is carried out:
I. by the storage node itself by a step 170; or
II. by its partner nodes via supernodes by a step 180; or
III. by instigating node via super nodes by step 190 by retrieval and running the hashing algorithm against that piece of data.

The data checking cycle repeats itself.

As a peer, whether an instigating node or a partner peer, namely one that has a same chunk, there are performed checks on the data, wherein the supernode queries the storage peer which responds with the result of the integrity check and updates this status on the storage peer. The instigating node or partner peer beneficially decides to forget this data and will replicate it in a more suitable location. If data fails the integrity check, the node itself will be marked as ‘dirty’ by a step 200, and such a ‘dirty’ status is appended to leaf node address to mark it as requiring further checks on the integrity of the data it holds by a step 210. Additional checks are carried out on data stored on the leaf node marked as ‘dirty’ by a step 220. If a pre-determined percentage of data is found to be dirty, a corresponding ‘dirty’ node is removed from the maidsafe.net network, except for message traffic by a step 230. A certain percentage of dirty data being established may conclude that this node is compromised or otherwise damaged and the maidsafe.net network would then be informed of this. At that point, the node will be removed from the maidsafe.net network, except for the purpose of sending it warning messages by a step 230.

This allows either having data stored on nodes of equivalent availability and efficiency, or dictating the number of copies of data required to maintain reliability.

Further modifications and improvements may be added without departing from the scope of the invention herein described.

With reference to FIG. 10, duplicate data is removed to increase, for example maximise, the efficient use of disk space of the m,aidsafe.net system. Prior to the initiation of the data backup process by a step 240, an internally generated content hash is optionally checked for a match against hashes stored on the Internet by a step 250, or against a list of previously backed up data 250. This beneficially allows only one backed up copy of data to be kept. Moreover, this also reduces a network-wide requirement to backup data, which has the exact same contents. Notification of shared key existence is passed back to instigating node by a step 260 to access authority check requested, which has to pass for a signed result which is to be passed back to the storage node. The storage node passes a shared key and database back to an instigating node by a step 270.

Such data is backed up via a shared key, which after proof of the file existing (260) on the instigating node, and the shared key 270 are shared with this instigating node. The location of the data is then passed to the node for later retrieval, if required.

Such a procedure maintains copyright as people can only backup what they prove to have on their systems, and not publicly share copyright-infringed data openly on the maidsafe.net network.

This data may be marked as protected, or not protected, by a step 280, which has check carried out for protected, or non-protected, data content. The protected data ignores a sharing process.

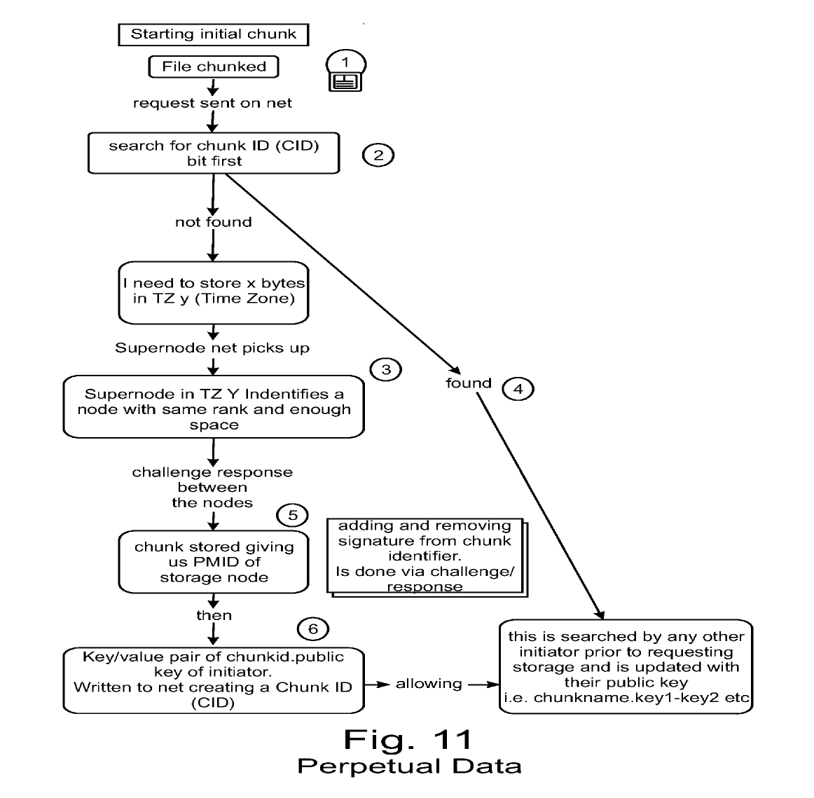

Next, Perpetual Data in the maidsafe.net system will be described with reference to FIG. 1, namely the principal element PT1, with reference also to FIG. 11.

According to a related aspect of the present disclosure, a file is chunked or split into constituent parts (1), wherein this process involves calculating the chunk size, preferably from known data such as the first few bytes of the hash of the file itself and preferably using a modulo division technique, for example a native XOR function of a data processor, to resolve a figure between the optimum minimum and optimum maximum chunk sizes for network transmission and storage.

Preferably, each chunk is then encrypted and obfuscated in some manner to protect the data. Preferably, a search of the network is carried out looking for values relating to the content hash of each of the chunks (2). Beneficially, the data chunks are firstly encrypted to generate corresponding encrypted data chunks, and then secondly the encrypted data chunks are subject to an obfuscation process, for example by swapping bytes between encrypted data chunks, for example by employing a modulo or XOR function. An XOR function for providing obfuscation is especially beneficial, in that the encrypted data chunks can be obfuscated very rapidly using XOR functions which to native to data processors employed to implement the maidsafe.net system.

If this is found (4), namely values relating to the content hash of each of the chunks are found, then the other chunks are identified too, wherein failure to identify all chunks may mean there is a collision on the maidsafe.net network of file names or some other machine is in the process of backing up the same file. A back-off time is calculated to check again for the other chunks. If all chunks are on the network, the file is considered backed up and the user will add their MID signature to the file after preferably a challenge response to ensure there a valid user and have enough resources to do this.

If no chunks are on the maidsafe.net network, the user, preferably via another node (3), requests the saving of the first copy, preferably in distinct time zones or by employing an alternative geographically dispersing method.

The chunk is stored (5) on a storage node, allowing there to be seen the PMID of the storing node, and for storing this PMID.

Then, preferably, a Key.value pair of chunkid. public key of initiator is written to the maidsafe.net network, creating a Chunk ID (CID) (6)

Next, storage and retrieval of data within the maidsafe.net system will be described, with reference to FIG. 1, and with reference the functional element P4, as aforementioned.

According to a related aspect of this disclosure, the data is stored in multiple locations. Each location stores the locations of its peers that hold identical chunks, namely at least identical in content, and they all communicate regularly to ascertain the health of the data. A preferable associated method is as follows:

STEP 1: Preferably, the data is copied to at least three disparate locations.

STEP 2: Preferably, each copy is performed via many nodes to mask the initiator of the copying.

STEP 3: Preferably, each local copy is checked for validity and checks are made that the preferably other two copies are also still valid; however, optionally, other than two copies can be employed if necessary.

STEP 4: Preferably, any single node failure initiates a replacement copy being made in another disparate location and the other associated copies are updated to reflect this change.

STEP 5: Preferably, the steps of storing and retrieving are carried out via other network nodes to mask the initiator.

STEP 6: Preferably, the method further comprises a step of renaming all files with a hash of their contents.

STEP 7: Preferably, each chunk optionally alters its name by a known process, such as a binary shift left of a section of the data. This allows the same content to exist, but also allows the chunks to appear as three different bits of data for the sake of not colliding on the maidafe.net network.

Preferably, each chunk has a counter attached thereto, that allows the maidsafe.net network to understand easily just how many users are attached to the chunk, either by sharing or otherwise. A given user requesting a ‘chunk forget’ will initiate a system question, if the given user is the only user using the chunk, and, if so, the chunk will be deleted and the given users required disk space reduced accordingly. This allows users to remove files no longer required and free up local disk space. Any file also being shared is preferably removed from the given user's quota and the given user's database record or data map (see later) is deleted.

Preferably, this counter is digitally signed by each node sharing the data and therefore requires a signed ‘forget’ or ‘delete’ command. Preferably, even ‘store’, ‘put’, ‘retrieve’ and ‘get’ commands should also be either digitally signed or preferably go through a PKI challenge response mechanism.

To ensure fairness, this method is preferably monitored by a supernode or similar to ensure the user has not simply copied the data map for later use without giving up the disk space for it. Therefore, the users private ID public key is beneficially used to request the forget chunk statement. This will be used to indicate the users acceptance of the ‘chunk forget’ command and allows the user to recover the disk space. Any requests against the chunk will preferably be signed with this key and consequently rejected, unless the users system gives up the space required to access this file.

Preferably, each user storing a chunk will append his/her signed request to the end of the chunk in an identifiable manner, for example prefixed with 80, or similar.

Forgetting the chunk means the signature is removed from the file. This again is done via a signed request from the storage node as with the original backup request.

Preferably, this signed request is another small chunk stored at the same location as the data chunk, with an appended postfix to the chunk identifier to show a private ID is storing this chunk. Any attempt by somebody else to download the file is rejected unless they first subscribe to it, namely a chunk is called “12345” so a file is saved called “12345<signed store request>”. This will allow files to be forgotten when all signatories to the chunk are gone. A user will send a signed no store′ or ‘forget’ and their ID chunk will be removed, and in addition if they are the last user storing that chunk, the chunk is removed. Preferably, this allows a private anonymous message to be sent upon chunk failure or damage, allowing a proactive approach for purposes of maintaining clean data.

Preferably, as a given node fails, other nodes preferably send message to all sharers of the chunk to identify the new location of the replacement chunk.

Preferably, any node attaching to a file and then downloading immediately is optionally considered an alert, and the maidsafe.net system beneficially takes steps to slow down this node's activity or even halt it to protect data theft.

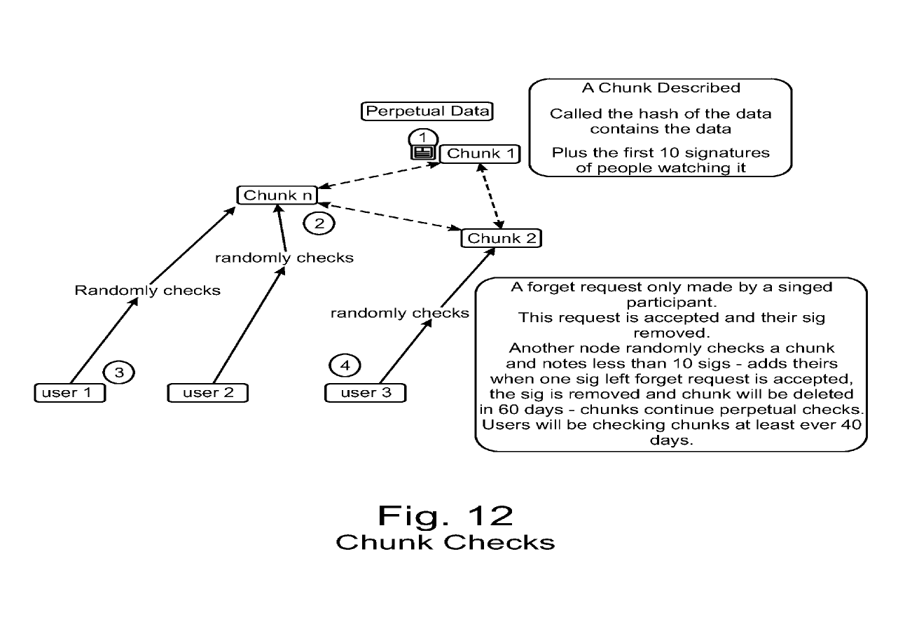

Next, there will be described Chunk Checks executed with the maidsafe.net system, with reference to FIG. 1 and the functional element P9, with further reference to FIG. 12.

STEP 1. A storage node of the maidsafe.net system containing a chunk 1 is operable to check its peers. As each peer is checked, it reciprocates the check. These checks are preferably split into two types:
I. An availability check, namely a simple network ping;
II. A data integrity check, in this instance the checking node takes a chunk and appends random data to it to generate a result, and then takes a hash of the result. It then sends the random data to the node being checked and requests the hash of the chunk with the random data appended. The result is compared with a known result and the chunk will be assessed as either healthy or not. If not healthy, further checks with other nodes occur to find the bad node.

STEP 2. There may be multiple storage nodes depending on the rating of machines of the maidsafe.net system and other factors. The above checking is carried out by all nodes from 1 to n (where n is total number of storage nodes selected for the chunk). Clearly, a poorly rated node will require to give up disk space in relation to the number of chunks being stored to allow perpetual data to exist. This is a penalty paid by nodes that are switched off.

STEP 3. The user who stored the chunk will check on a chunk from one storage node which is randomly selected. This check will ensure the integrity of the chunk and also ensure there are at least ten, for example, other signatures existing already for the chunk. If there are not such signatures and the users ID is not listed, the user signs the chunk.

STEP 4. This shows another example of another user checking the chunk. It will be appreciated that the user checks X (40 days in this diagram) are always at least 75% of the forget time retention (Y), namely when a chunk is forgotten by all signatories it is retained for a period of time Y. Optionally, this algorithm that will is susceptible to being further continually developed.

Next, storage of Additional Chunks will be described with reference to FIG. 12.

STEP 1: The maidsafe.net system employs in operation, for example, a maidsafe.net program with a given user logged in, so that a corresponding MID exists, and there has been chunked a file. In en event that the program has already stored a chunk and is now looking to store additional chunks, a corresponding Chunk ID (CID) should exist on the maidsafe.net network. This process then proceeds to retrieve this CID.

STEP 2: The CID as shown in storing initial chunk, contains the chunk name and any public keys that are sharing the chunk. In this instance, it should only be the given user's key as he/she is first person storing the chunks; other users would be in a back-off period to see if the given user backs other chunks up. In the process, there is shifted the last bit (could be any function on any bit as long as the given user can replicate it).

STEP 3. There is then a check performed that till not be any collision with any other stored chunk on the maidsafe.net network, namely it does a CID search again.

STEP 4: There is then issued a broadcast to supernodes of the maidsafe.net system, namely the supernodes to which the given user is connected, stating there is a need to store X bytes and any other information about where the given user requires to store it (for example, geographically in the given user's case, an associated time zone (TZ))

STEP 5: The supernode network finds a storage location for the given user with the correct rank, and so forth.

STEP 6: The chunk is stored after a successful challenge response, namely in the maidsafe.net network. MIDs are required to ensure they are talking or dealing with validated nodes, so, to accomplish this, a challenge process is carried out as follows as provided in Table 7, where a sender is denoted by [S], and a receiver is denoted by [R].

TABLE 7
Steps of challenge process in the maidsafe.net system

| Party | Action |
|---|---|
| [S] | I wish to communicate (store retrieve forget data and so |
| | forth) and I am MAID. |
| [R] | Retrieves MAID public key from DHT, and encrypts a |
| | challenge (optionally a very large number encrypted with |
| | the public key retrieved). |
| [S] | Gets key and decrypts and encrypts. |
| [R] | Answer with his/her challenge number also encrypted |
| | with [R]'s public key. |
| [R] | Receives response and decrypts his challenge and |
| | passes back answer encrypted again with [S] public key |
| | (Communication is now authenticated between these two |
| | nodes). |

STEP 7: The CID is then updated with the second chunk's name and the location at which it is stored. This process is repeated for as many copies of a given chunk that are required.

STEP 8: Copies of chunks will be dependent on many factors, including file popularity, namely popular files may require to be more dispersed closer to nodes and have more copies. Very poorly ranked machines may require an increased amount of chunks to ensure they can be retrieved at any time (poorly ranked machines will therefore have to give up more space.

Next, there will be described Security Availability within the maidsafe.net system, with reference to FIG. 1 and its associated functional element P3.

According to a related aspect of the present disclosure, there is employed a method, wherein each file is split into small chunks and encrypted to provide security for the data, as aforementioned. Only a person, or a group, to whom the overall data belongs, will know one or more locations of other related, but dissimilar, chunks of data.

Preferably, each of the above chunks does not contain location information for any other dissimilar chunks; which provides for security of data content, a basis for integrity checking and redundancy.

Preferably, the method further comprises a step of only allowing the given person or group) to whom the data belongs to have access to it, preferably via a shared encryption technique which allows persistence of data.

Preferably, the checking of data or chunks of data between machines of the maidsafe.net system is carried out via any presence type protocol such as a distributed hash table network.

Preferably, on an occasion when all data chunks have been relocated, namely the user has not logged on for a while, a redirection record is created and stored in the super node network, namely a three copy process, in a similar manner to data storage; therefore, when a given user requests a check, the redirection record is given to the given user to update his/her database, which provides efficiency that in turn allows data resilience in cases where network churn, namely processing and communication capacity of the maidsafe.net system, is a problem, as in peer-to-peer (P2P) or distributed networks. This system message can be preferably passed via the messenger system described herein.

Preferably, the system optionally allows a user to search for his/her chunks and through a challenge response mechanism, locates and authenticates himself/herself to have authority to get/forget his/her chunks.

Further users can decide on various modes of operation, preferably such as maintaining a local copy of all files on their local machine, unencrypted or chunked or chunk and encrypt even local files to secure machine (preferably referred to as “off-line mode” operation), or indeed users may decide to remove all local data and rely completely on preferably maidsafe.net or similar system to secure their data.

Next, there will described Self Healing within the madisafe.net system, with reference to FIG. 1, and its associated functional feature P2.

According to a related aspect of the present disclosure, a self healing network method is provided via the following process:

As data or chunks become invalid, data is ignored from that location; data or chunks are recreated in a new and safer location. The original location is marked as bad. Peers note this condition and add the bad location to a watch list.

Such a manner of operation for the madisafe.net system provided by the method is able to prevent the introduction of viruses; worms and such like, and thus allows for faulty machines/equipment to be identified automatically.

Preferably, the maidsafe.net system employs a network layer which uses SSL or TLS channel encryption to prevent unauthorised access or snooping.

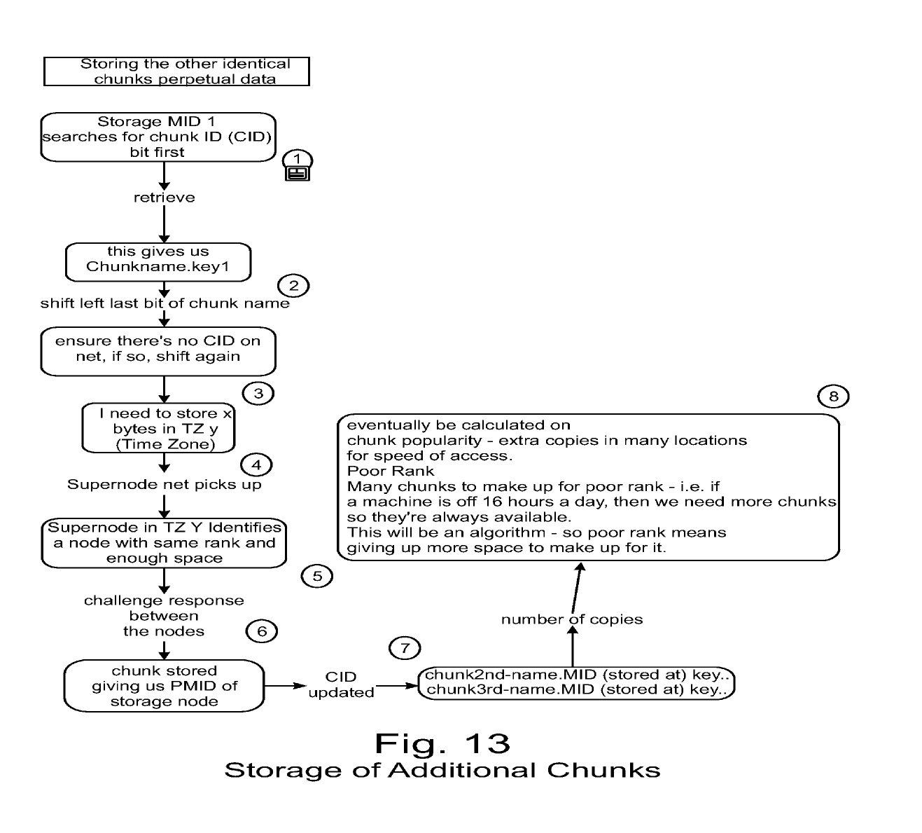

Next, Self Healing within the maidsafe.net system will be described, with reference to FIG. 13.

STEP 1: A data element called a Chunk ID (CID) is created for each chunk. Added to this is the also stored at MID for the other identical chunks. The other chunk names are also here as they may be renamed slightly, for example by bit shifting a part of the name in a manner that calculable.

STEP 2: All storing nodes (related to this chunk) have a copy of this CID file, or can access it at any stage from the DHT network, giving each node knowledge of all others.

STEP 3: Each of the storage nodes have their copy of the chunk.

STEP 4: Each node queries its partner's availability at frequent intervals. On less frequent intervals, a chunk health check is beneficially requested. This involves a node creating some random data and appending this to its chunk and taking a corresponding hash thereof. The partner node will be requested to take the random data and do likewise and return the hash result. This result is checked against the result the initiator had and chunk is then deemed healthy or not. Further tests can be optionally done as each node knows the hash their chunk should create, and can self check in that manner on error and report a dirty node.

STEP 5: In an event of there occurring a node fail, a designation of a dirty chunk is created.

STEP 6: The first node to note this dirty chunk carries out a broadcast to other nodes to communicate that it is requesting a move of the data.

STEP 7: The other nodes agree to have CID updated; optionally, they may carry out their own check to confirm this.

STEP 8: A broadcast is sent to the supernode network closest to the storage node that failed, to state a re-storage requirement.

STEP 9. The supernode network of the maidsafe.net system picks up the request.

STEP 10: The request is to the supernode network to store x amount of data at a rank of y.

STEP 11: A supernode replies with a location

STEP 12: The storage node and new location carry out a challenge response request to validate each other.

STEP 13: The chunk is stored and the CID is updated and signed by the three or 1479 more nodes, for example, storing the chunk.

Next, there will be described Peer Ranking with reference to FIG. 1, and in relation to the function element P1.

According to a related aspect of the present disclosure, there is an addition of a peer ranking mechanism, wherein each node (leaf node) monitors its own peer node's resources and availability in a scalable manner. Beneficially, in the maidsafe.net system, nodes constantly perform this monitoring function.

Each data store, whether a network service, physical drive or otherwise, is monitored for availability. A ranking figure is appended and signed by the supply of a key from the monitoring supernode, this being preferably agreed by more supernodes to establish a consensus before altering the ranking of the node. Preferably, the new rank will be appended to the node address or by a similar mechanism to allow the node to be managed in terms of what is stored there and how many copies there has to be of the data for it to be seen as perpetual.

Each piece of data is checked via a content hashing mechanism. This is preferably carried out by the storage node itself or by its partner nodes via supernodes, or by an instigating node via supernodes by retrieving and running the hashing algorithm against that piece of data.

Preferably, as a peer, whether an instigating node or a partner peer, (namely one that has same chunk), checks the data, wherein the supernode querying the storage peer responds with the result of the integrity check and updates this status on the storage peer. The instigating node or partner peer then decide to forget this data and subsequently replicates it in a more suitable location. If data fails the integrity check, the node itself will be marked as ‘dirty’ and this status will preferably be appended to the node's address for further checks on other data to take this into account. Preferably, a certain percentage of dirty data being established may conclude that this node is compromised or otherwise damaged, and the network is then informed of this. At that point in time, the node is removed from the network except for the purpose of sending it warning messages.

In general, the node ranking figure will take into account at least one of:
i. availability of the network connection;
ii. availability of resources;
iii. time on the network with a rank (later useful for effort based trust model); and
iv. an amount of resource (including network resources) and also the connectivity capabilities of any node (i.e. directly or indirectly contactable).

This then allows data to be stored on nodes of equivalent availability and efficiency, and to determine the number of copies of data required to maintain reliability.

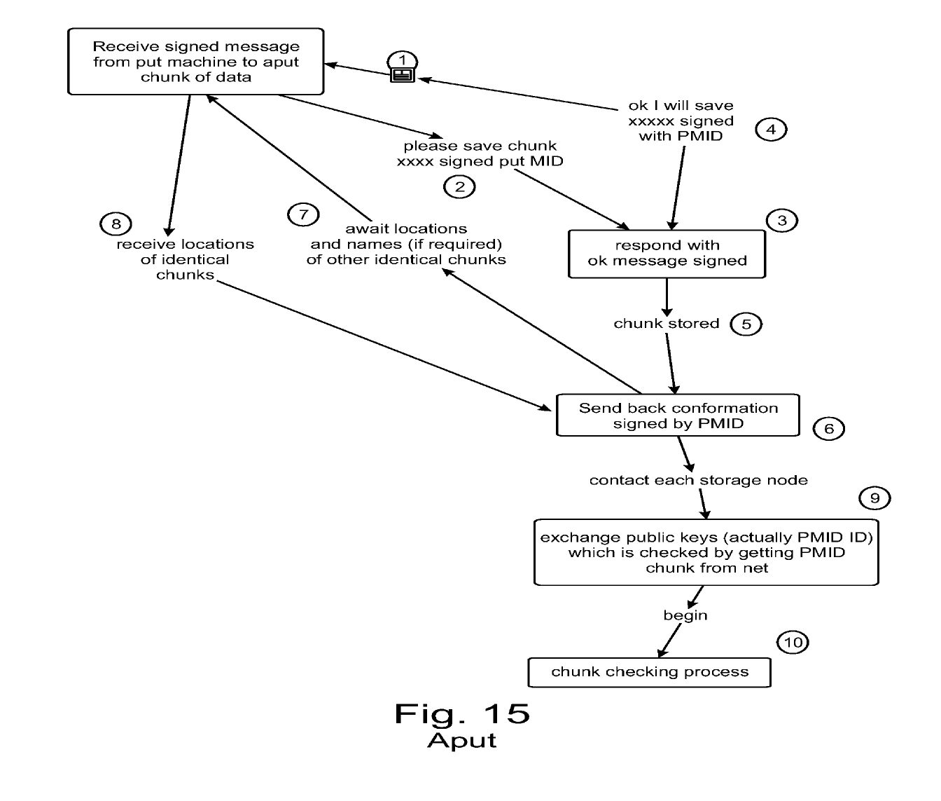

Aput in the maidsafe.net system will next be described, with reference to FIG. 15.

Here, the MID is the MID of the machine saving data to the maidsafe. net network, and the PMID is the ID of the storage node chunk server. The communication is therefore between a maidsafe.net application with a logged in user, namely to provide MID, and a chunking system on the network, somewhere (namely a storage node). In an associated method, following steps are performed:

STEP 1: A message signed with a user's MID (checked by getting the MAID packet from the net) is received requesting storage of a data chunk.

STEP 2: This message is a specific message stating the storage node's ID (PMID) and the chunk name to be saved and signed (namely, this is a unique message).

STEP 3: The chunk server decides whether or not it will store the chunk.

STEP 4: A signed message is returned stating if the PMID is able to store this chunk (chunkID).

STEP 5: The chunk is stored and checked (namely subject to a SHA check).

STEP 6: A message is sent back to state that the chunk is saved and is OK. This is signed by the PMID of the chunk server.

STEP 7: The chunk server awaits the locations of the other identical chunks.

STEP 8: Locations of the identical chunks returned to the chunk server are signed with the MID.

STEP 9: Each storage node is contacted and public keys exchanged; PMIDs are provided.

STEP 10: The chunk checking process is initiated.

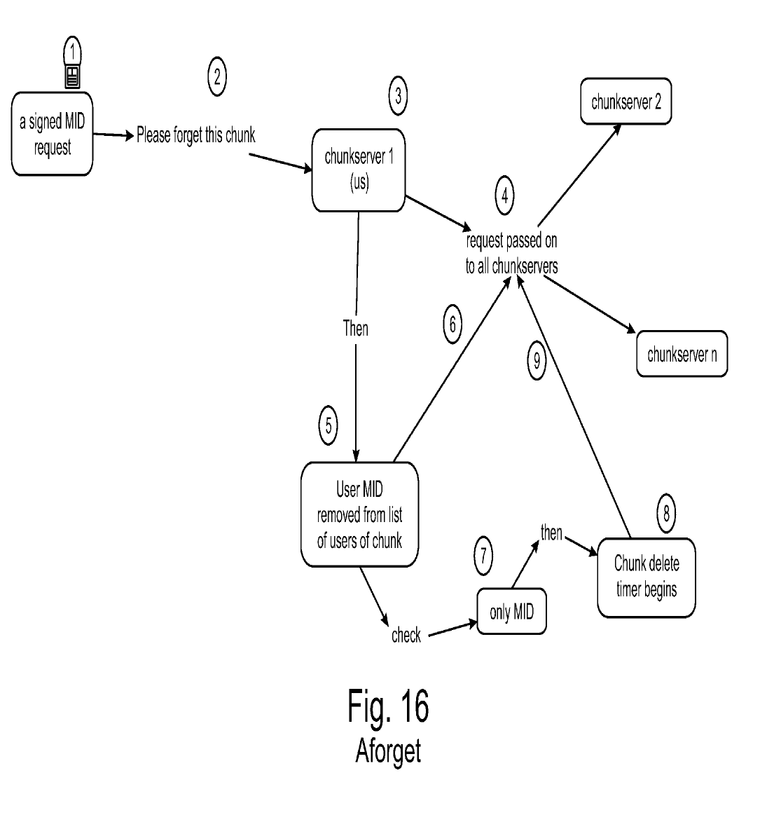

Next, a function of the maidsafe.net system, namely Aforget, will be described with reference to FIG. 16. A method of providing Aforget beneficially includes following steps:

STEP 1: A user requests that a file is to be deleted from his/her backup (namely forgotten). The maidsafe.net system signs a request using the user's MID.

STEP 2: The request is sent to a chunk server (namely to a storage node).

STEP 3: The storage node picks up the request.

STEP 4: The storage node sends the signed request to the other storage nodes that have this chunk.

STEP 5: The MID is checked as being on the list of MID's that are watching the chunk (it will be appreciated that only a few, for example twenty, are typically ever listed)

STEP 6: The other storage nodes are notified of this.

STEP 7: If this is the only MID listed, then all owners are possibly gone.

STEP 8: Chunk delete timer begins; this timer will always be higher than a user check interval, for example a timer of 60 days and a user check interval of 40 days.

STEP 9: This information is also passed to other storage nodes.

Next, Duplicate Removal will be described, with reference to FIG. 1, and its associated functional element P5.

According to a related aspect of the present disclosure, prior to data being backed up, the content hash is optionally checked against a list of previously backed up data. This will allow only one backed up copy of data to be kept, thereby reducing the network-wide requirement to backup data that has the exact same content. Preferably, this is be done via a simple search for existence on the maidsafe.net network of all chunks of a particular file.

Preferably, such data is backed up via a shared key or mechanism of appending keys to chunks of data. After proof of the file existing on the instigating node, the shared key is shared with the instigating node and the storing node issues a challenge response to add their ID to the pool, if it is capable of carrying out actions on the file such as get/forget (namely, delete). The location of the data is then passed to the node for later retrieval if required.

This manner of operation maintains copyright as people can only backup what they prove to have on their systems and not easily publicly share copyright infringed data openly on the maidsafe.net network.

Preferably, data may be marked as protected or not protected. Preferably, protected data ignores sharing process.

Next, Chunking will be described, with reference to FIG. 1, and also the functional element P7 thereof.

According to a related aspect of the present disclosure, files are split, preferably using an algorithm to work out the chunk size into several component parts. The size of the parts is preferably worked out from known information about the file as a whole, preferably the hash of the complete file. This information is run through an algorithm, such as adding together the first x bits of the known information and using modulo division, for example an XOR logic operation, to give a chunk size that allows the file to preferably split into at least three parts.

Preferably, known information from each chunk is used as an encryption key. This is preferably done by taking a hash of each chunk and using this as the input to an encryption algorithm to encrypt another chunk in the file. Preferably, this is a symmetrical algorithm, such as AES256 or similar.

Preferably, this key is input into a password-creating algorithm, such as pbkdf, and an initial vector and key calculated from that. Preferably, the iteration count for the pbkdf algorithm is calculated from another piece of known information, preferably the sum of bits of another chunk or similar.

Preferably each initial chunk hash and the final hash after encryption are stored somewhere for later decryption.

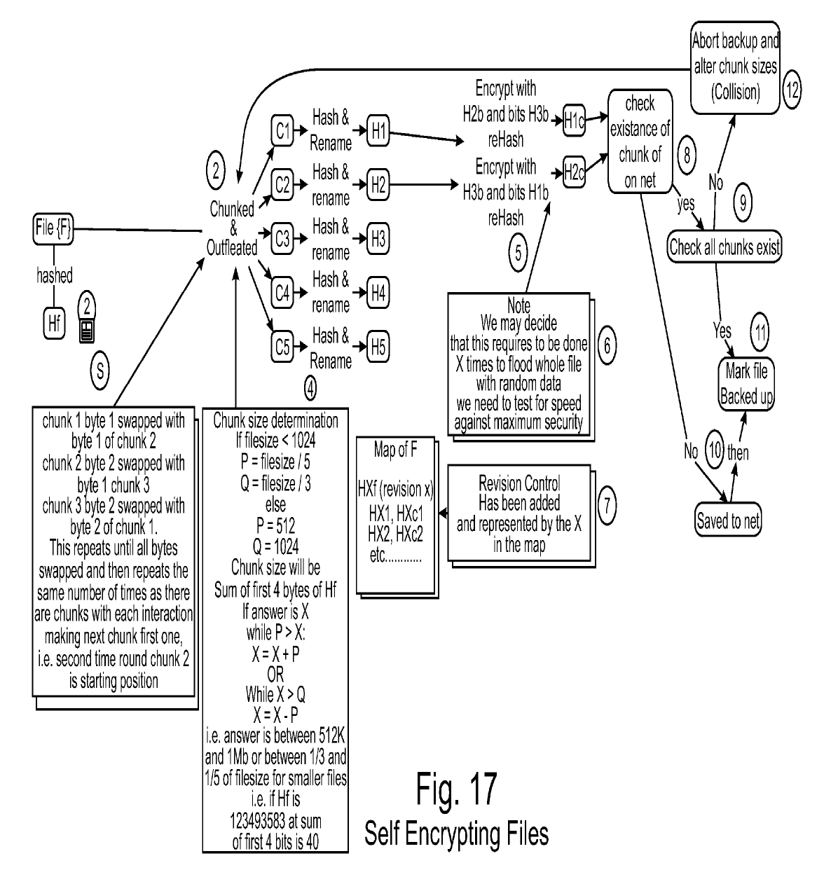

Next, Self Encrypting Files will be described, with reference to FIG. 1, in respect of the principal element PT2 and FIG. 17. There is provided in the maidsafe.net system a method of self encrypting files, wherein the method has following steps:

STEP 1: Take a content hash of a file or data element.

STEP 2: Chunk a file with preferably a random calculable size, namely based on an algorithm of the content hash (to allow recovery of file). Moreover, obfuscate the file such as in STEP 3.

STEP 3: Obfuscate the chunks to ensure safety, even if encryption is eventually broken (as with all encryption if given enough processing power and time), wherein obfuscation if performed as follows, for example:
I. chunk 1 byte 1 swapped with byte 1 of chunk 2;
II. chunk 2 byte 2 swapped with byte 1 chunk 3;
III. chunk 3 byte 2 swapped with byte 2 of chunk 1;
IV. This repeats until all bytes swapped and then repeats the same number of times as there are chunks with each iteration making next chunk first one;
V. namely, second time round chunk 2 is starting position.

However, it will be appreciated that other approaches to perform obfuscation by swapping bytes between the data chunks are also possible, within the scope of the present disclosure.

STEP 4: Take hash of each chunk and rename chunk with its hash.

STEP 5: Take h2 and first x bytes of h3 (6 in the example case here) and either use modulo division, XOR or similar to get a random number between two fixed parameter (in the example case here, 1000) to get a variable number. Use the above random number and h2 as the encryption key to encrypt hi or use h2 and the random number as inputs to another algorithm (pdbfk2 in the example case here) to create a key and iv, (namely initialisation vector).

STEP 6: This process may be repeated multiple times to dilute any key throughout a series of chunks.

STEP 7: Chunk name i.e. In (unencrypted) and h1c (and likewise for each chunk) written to a location for later recovery of the data. Added to this, it is advantageous simply to update such a location with new chunks if a file has been altered, thereby creating a revision control system where each file can be rebuilt to any previous state.

STEP 8: The existence of the chunk is checked on the maidsafe.net network to ensure it is not already backed up. All chunks are optionally checked at this time, for example in a similar manner.

STEP 9: If a chunk exists, all chunks must be checked for existence.

STEP 10: The chunk is saved.

STEP 11: The file is marked as being backed up.

STEP 12: If a collision is detected, the process is redone altering the original size algorithm (STEP 2) to create a new chunk set, each system will be aware of this technique and will do the exact same process until a series of chunks do not collide. There will be a back-off period here to ensure the chunks are not completed due to the fact another system is backing up the same file. The original chunk set will be checked frequently in case there are false chunks or ones that have been forgotten. If the original names become available, the file is reworked using these parameters.

Next, there will described Duplicate Removal within the maidsafe.net system, with reference to FIG. 1, and its associated functional element P5.

According to a related aspect of the present disclosure, data that is chunked and ready for storing can be stored on a distributed network, but a search should preferably be carried out for the existence of all associated chunks created. Preferably, the locations of the chunks have the same ranking (from an earlier ranking system) as user or better, otherwise the existing chunks on the network are promoted to a location of equivalent rank, at least. If all chunks exist, then the file is considered as already backed up. If less than all chunks exist, then this will preferably be considered as a collision (after a time period) and the file will be re-chunked using secondary algorithms (preferably just adjusted file sizes). This allows duplicate files on any two or more machines to be only backed up once, although through perpetual data several copies will exist of each file; this is limited to an amount that will maintain perpetual data.

Next, there will be described Encrypt-Decrypt operations within the maidsafe.net system, with reference to FIG. 1 and its associated functional element P8.

According to a related aspect of the present disclosure, the actual encrypting and decrypting is carried out via knowledge of the file's content and this is somehow maintained (see next). Keys are generated and preferably stored for decrypting. Actually encrypting the file will preferably include a compression process and further obfuscation methods. Preferably, the chunk is stored with a known hash, preferably based on the contents of that chunk. It is optionally beneficial to compress the data, thereafter splitting it into data chunks, applying encryption to the data chunks, and finally applying obfuscation based on a modulo computation or simply an XOR between the data chunks. XOR is particular effective and fast, because it is often a native function of a contemporary data processor (for example allows fast real-time data processing, ideal for real-time secure video conferencing, secure video surveillance, secure telephone calls and so forth].

Decrypting the file preferably requires the collation of all chunks and rebuilding of the file itself. The file preferably has its content mixed up by an obfuscation technique, thereby rendering each chunk useless on its own.

Preferably, every file is subjected to a process of byte (or preferably bit) swapping between its chunks to ensure the original file is rendered useless without all chunks.

This process preferably involves running an algorithm which preferably takes the chunk size and then distributes the bytes in a pseudo-random manner, preferably taking the number of chunks and using this as an iteration count for the process. This beneficially protects data, even in an event of somebody getting hold of the encryption keys, as the chunked data is rendered useless even if transmitted in the open without encryption.

This defends against somebody copying all data and storing for many years until decryption of today's algorithms is possible, although this is many years away.

This also defends against somebody; instead of attempting to decrypt a chunk by creating the enormous amount of keys possible, (in the region of 254) rather instead creating the keys and presenting chunks to all keys; if this were possible (which is unlikely), a chunk would decrypt. The process defined here makes such an attempt useless.

All data will now be considered to be diluted throughout the original chunks, and preferably additions to this algorithm only further strengthen the process.

Next, there will be described a functionality “Identify Chunks” in the maidsafe.net system, with reference to FIG. 1 and the functional element P9 thereof.

According to a related aspect of the present disclosure, a chunk's original hash or other calculable unique identifier is stored. Such storage is preferably implemented with the final chunk name. This aspect defines that each file will have a separate map, preferably a file or database entry, to identify the file and the name of its constituent parts. Preferably, this map includes local information to users, such as original location and rights (such as a read only system and so forth). Preferably, some of this information can be considered shareable with others, such as filename, content hash and chunks names.

Next, ID Data with Small File will be described with reference to FIG. 1 and its associated functional element P11.

According to a related aspect of the present disclosure, these data maps may be very small in relation to the original data itself, allowing transmission of files across networks such as the Internet with extreme simplicity, security and bandwidth efficiency. Preferably, the transmission of maps is carried out in a very secure manner, but failure to do this is akin to a security situation pertaining to e-mailing in contemporary times a file in its entirety.

This allows a very small file such as the data map or database record to be shared or maintained by a user in a location not normally large enough to fit a file system of any great size, such as on a PDA or mobile phone. The identification of the chunk names, original names and final names are all that is required to retrieve the chunks and rebuild the file with certainty.

With data maps in place, a users whole machine, or all its data, can exist elsewhere. Simply retrieving the data maps of all data, is all that is required to allow the user to have complete visibility and access to all his/her data as well as any shared files that he/she have agreed to.

Next, Revision Control will be described, with reference to FIG. 1 and its associated function element P10.

According to a related aspect of the present disclosure, as data is updated and the map contents alter to reflect the new contents, this preferably does not require the deletion or removal of existing chunks, but instead allows the existing chunks to remain and the map appended to with an indication of a new revision existing. Preferably, further access to the file automatically open the last revision, unless requested to open an earlier revision.

Preferably, revisions of any file can be forgotten or deleted (preferably after checking the file counter or access list of sharers as above). This allows users to recover space from revisions that are no longer required.

Next, there will be described Create Map of Maps with reference to FIG. 1 and its associated functional element P15.

According to a related aspect of the present disclosure, data identifiers, preferably data maps as mentioned earlier, can be appended to each other in a way that preferably allows a single file or database record to identify several files in one as a form of share. Such a share can be private to the individual, thereby replacing the directory structure of files to which users are normally accustomed, and replacing this with a new structure of shares very similar to volumes or filing cabinets, as this is more in line with normal human nature and should make things simpler when using the maidsafe.net system.

Next, Share Maps will be described with reference to FIG. 1 and its associated functional element P16.

According to a related aspect of the present disclosure, this map of maps will preferably identify the users connected to it via some public ID that is known to each other user, with the map itself being passed to users who agree to join the share. This is preferably implemented via an encrypted channel such as ms messenger or similar. This map is beneficially then accessed at whatever rank level users have been assigned. Preferably, there are access rights, such as read/delete/add/edit as is typically utilized in contemporary times. As a map is altered, the user instigating this is checked against the user list in the map to see if this is allowed. If not, the request is ignored, but preferably the users may then save the data themselves to their own database or data maps as a private file, or even copy the file to a share for which they have access rights. These shares preferably also exhibit the revision control mechanism described above.

Preferably, joining the share means that the users subscribe to a shared amount of space and reduce the other subscription, for example a 10 Gb share is created, then the individual gives up 10 Gb (or equivalent depending upon system requirements which may be a multiple or divisor of 10 Gb). Another user joining means they both have a 5 Gb space to give up and 5 users would mean they all have a 2 Gb or equivalent space to give up. So with more people sharing, requirements on all users reduce.

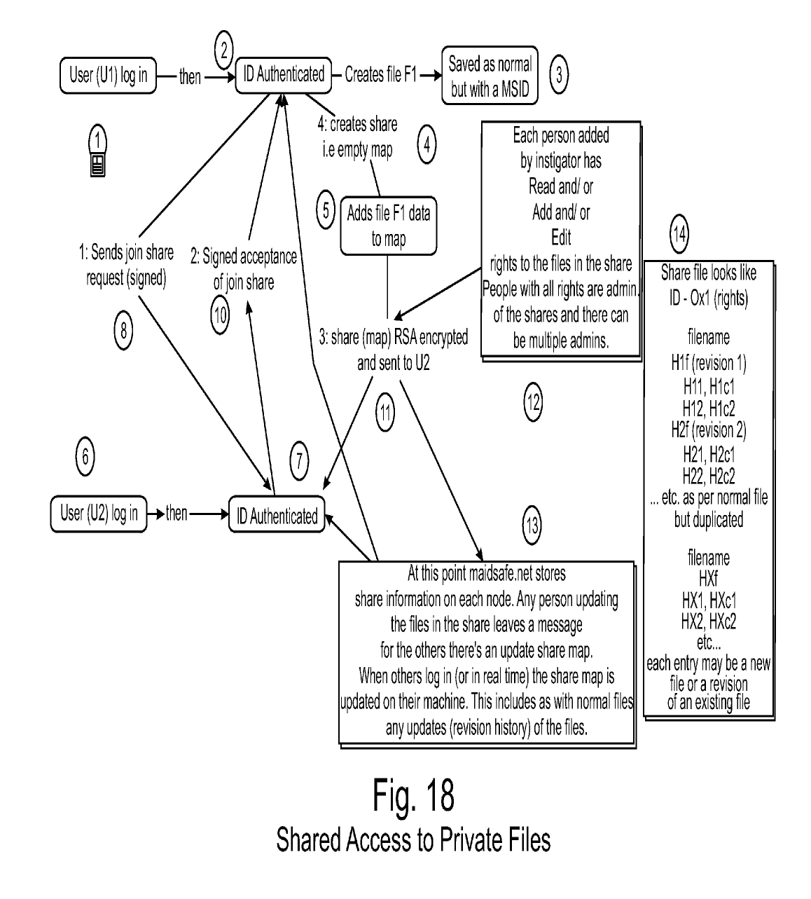

Next, Shared Access to Private Files will be described in greater detail with reference to FIG. 1 and its associated principal element PTS, and also with reference to FIG. 18. There is optionally employed a method including following steps:

STEP 1: User 1 logs onto the maidsafe.net network.

STEP 2: Authentication of User 1's ID is performed, namely User 1. gets access to his/her public and private keys to sign messages. This should NOT be stored locally, but should have been retrieved from a secure location-anonymously and securely.

STEP 3: User 1 saves a file as normal (encrypted, obfuscated, chunked), and stored on the net via a signed and anonymous ID. This ID is a special maidsafe.net Share ID (MSID) and is basically a new key pair created purely for interacting with the share users—to mask the user's MID (namely, it. cannot be tied to a MPID via a share). So again, the MSID is a key pair and the ID is the hash of the public key; this public key is stored in a chunk called the hash and signed and put on the maidsafe.net network for others to retrieve and confirm that the public key belongs to the hash.

STEP 4: User creates a share, which is a data map with some extra elements to cover users and privileges.

STEP 5: File data added to file map is created in the backup process, with one difference, namely that this is a map of maps and may contain many files, see STEP 14 below.

STEP 6: User 2 logs into the maidsafe.net system.

STEP 7: User 2 has authentication details (namely, his/her private MPID key) and can sign/decrypt with this MPID public key.

STEP 8: User 1 sends a share join request to user 2 (shares are invisible on the ne, namely nobody except the sharers to know they are there).

STEP 9: User 1 signs the share request to state he/she will join the share. He/she creates his/her MSID key pair at this time. The signed response includes User 2's MSID public key.

STEP 10: A share map is encrypted or sent encrypted (optionally via a secure messenger) to User 1, along with the MSID public keys of any users of the share that exist. It will be appreciated that the transmission of MSID public key is optionally not be required, as the MSID chunks are saved on the maidsafe.net network as described in STEP 3, so any user can check the public key at any time; this just saves the search operation on that chunk to speed the process up slightly.

STEP 11: Each user has details added to the share these include public name (MPID) and rights (read/write/delete/admin and so forth).

STEP 12: A description of the share file is provided. Note that as each user saves new chunks, he/she does so with the MSID keys; this means that if a shares is deleted or removed, the chunks still exist in the user's home database and he/she can have the option to keep the data maps and files as individual files or simply forget them all.

It will be appreciated that, as a user opens a file, a lock is transmitted to all other shares and they will only be allowed to open a file read only; they can request unlock (i.e. another user unlocks the file, meaning it becomes read only). Non-logged-in users will have a message buffered for them; if the file is closed, the buffered message is deleted (as there is no point in sending it to the user now) and logged-in users are updated also.

This will take place using the messenger component of the maidsafe.net system to receive automatically messages from share users about shares (but being limited to that).

Next, there will be described Provide Public ID with reference to FIG. 1 in association with the functional element P17.

According to a related aspect of the present disclosure, a public and private key pair is created for a network, where, preferably, the user is anonymously logged on, and preferably has a changeable pseudo-random private ID which is only used for transmission and retrieval of ID blocks, giving access to that network.

Preferably, this public-private key pair is associated with a public ID. This ID is transmittable in a relatively harmless way, using almost any method including in the open (email, ftp, www and so forth), but preferably in an encrypted form. Preferably, this ID should be simple enough to remember, such as a phone number type length. Preferably, this ID will be long enough, however, to cope with all the World's population and more, therefore it would be preferably approximately at least eleven characters long.

This ID can be printed on business cards or stationary like a phone number or email address, and cannot be linked to the users private ID by external sources. However, the users own private information makes this link by storing the data in the ID bit that the user retrieves when logging in to the maidsafe.net network, or via another equally valid method of secure network authentication.

This ID can then be used in data or resource sharing with others in a more open manner than with the private ID. This keeps the private ID private and allows much improved inter-node or inter-person communications.

Next, there will be described Secure Communications with reference to FIG. 1 in association with the functional element P18.

According to a related aspect of the present disclosure, the communications between nodes should be both private and validated. This is preferably irrefutable, but there should be options for refutable communications, if required. For irrefutable communications, the user logs onto the miadsafe.net network and retrieves his/her key pair and ID. This is then used to start communications. Preferably, the user's system will seek another node to transmit and receive from in a random manner, this adds to the masking of the users private ID as the private ID is not used in any handshake with network resources apart from logging into the maidsafe.net network.

As part of the initial handshake between users, a key may be passed. Preferably, this is a code passed between users over another communications mechanism in a form such as a pin number known only to the users involved, or it may be as simple as appending the users name and other information to a communication request packet such as exists in some instant messaging clients today, for example “David wants to communicate with you: allow/deny/block”.

Unlike many contemporary communication systems, this is carried out on a distributed server-less network. This however presents a problem of what to do when users are off-line. Contemporary messages are either, stopped or stored on a server, and in many cases not encrypted or secured. The present disclosure allows users to have messages securely buffered whilst off-line. This is preferably achieved by the node creating a unique identifier for only this session and passing that ID to all known nodes in the users address book. Users on-line get this immediately, users off-line have this buffered to their last known random ID. This ensures that the ability to snoop on a users messages is significantly reduced as there is no identifier to people outside the address book as to the name of the random ID bit the messages are stored to. The random ID bit is preferably used as the first part of the identified buffer file name, and when more messages are stored, then another file is saved with the random ID and a number appended to it representing the next sequential available number. Therefore, a user will log on and retrieve the message sequentially. This allows buffered secured and distributed messaging to exist.

Next, there will be described Document Signing with reference to FIG. 1 and its associated functional element P19.

According to a related aspect of the present disclosure, a by-product of securing communications between nodes using asymmetric encryption is as previously stated, introducing a non-refutable link. This allows for not only messages between nodes to be non-refutable, but also for documents signed in the same manner as messages to be non-refutable. Today, somebody can easily steal a user's password or purposely attack users as they are not anonymous; this embodiment of the present disclosure provides a great deal of anonymity and backs this up with access to resources. Documents may be signed and passed as legally enforceable between parties as a contract in many countries.

Next, there will be described Contract Conversations with reference to FIG. 1 and its associated functional element P20.

According to a related aspect of the present disclosure, a conversation or topic can be requested under various contracted conditions. The maidsafe.net system may have a non-disclosure agreement as an example, and both parties digitally sign this agreement automatically on acceptance of a contract conversation. In this case, there is considered a non-disclosure conversation. This will preferably speed up and protect commercial entities entering into agreements, or where merely investigating a relationship. Preferably, other conditions can be applied here, such as preferably full disclosure conversations, purchase order conversations, contract signing conversations and so forth. This is all carried out via a system preferably having ready made enforceable contracts for automatic signing. These contracts may preferably be country-specific or legal-domain-specific and require to be enforceable under the law of the countries where the conversation is happening. This requires the users preferably to automatically use a combination of geographic IP status and by selecting which is their home country, and where are they are at that time located and having that conversation.

Preferably, only the discussion thread is under this contract, allowing any party to halt the contract but not the contents of the thread which is under contract.

Preferably, there can also be a very clear intent statement for a conversation to which both parties agree. This statement beneficially forms a basis of a contract in an event of any debate. The clearer the intent statement is, the better it is for enforceability. These conversations are potentially not enforceable, but should lead to simplifying any resolution required at a later date. Preferably, this can be added together with an actual contract conversation, such as a non-disclosure agreement to form a pack of contracts per conversation. Contract conversations will be clearly identified as such with copies of the contracts easily viewable by both parties at any time; these contracts will preferably be data maps and be very small in terms of storage space required.

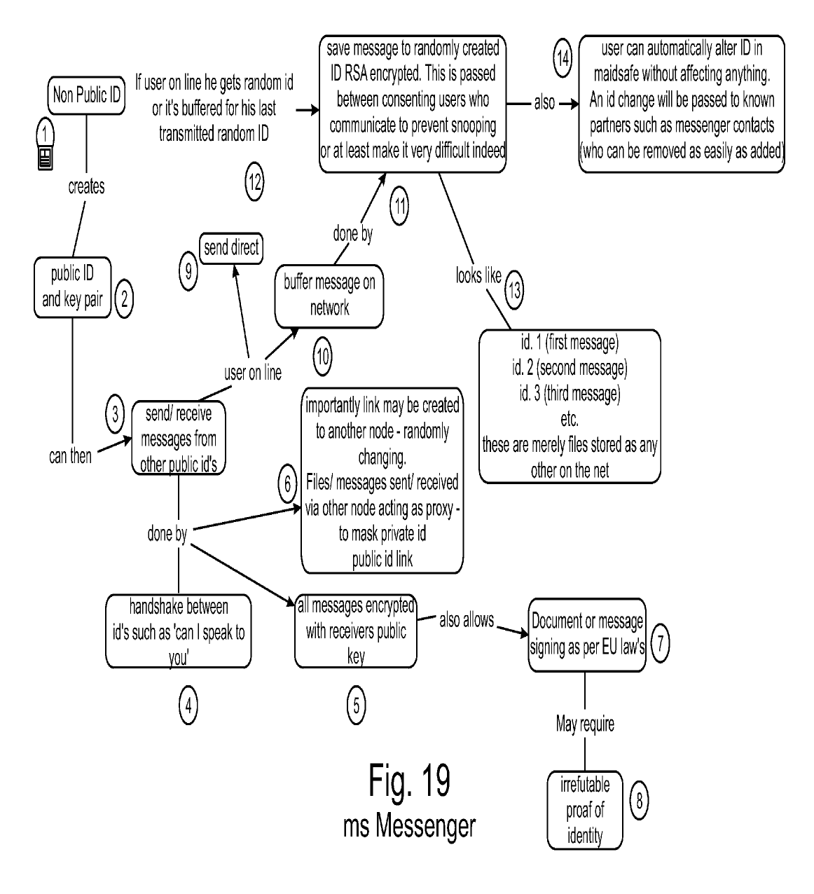

Next, there will be described ms_messenger with reference to FIG. 1 and its associated principal element PT6, and also with reference to FIG. 19. Beneficially, in the maidsafe.net system, there is utilized a method having following steps:

STEP 1: A non-public ID, preferably one which is used in some other autonomous system, is used as a sign in mechanism and creates a Public ID key pair.

STEP 2: The user selects or creates his/her public ID by entering a name that can easily be remembered (such as a nickname); the network is checked for a data element existing with a hash of this, and if not there, this name is allowed. Otherwise, the user is asked to choose again.

STEP 3. This ID, called the MPID (maidsafe.net public ID), can be passed freely between friends, or printed on business cards and so forth, in a manner akin to a contemporary e-mail address.

STEP 4: To initiate communications, a user enters the nickname of the person with whom he/she is trying to communicate, together with optionally a short statement, for example like a prearranged pin or other challenge. The receiver agrees or otherwise to this request; disagreeing means a negative score starts to build with the initiator. This score may last for hours, days or even months, depending on regularity of refusals. A high score will accompany any communication request messages. Users may set a limit on how many refusals a user has prior to being automatically ignored.

STEP 5: All messages now transmitted are done so in an encrypted manner, with the receiving party's public key, making messages less refutable.

STEP 6. These messages may go through a proxy system or additional nodes to mask the location of each user.

STEP 7: this maidsafe.net system also allows document signing (digital signatures) and also contract conversations. This is where a contract is signed and shared between the users. Preferably, this signed contract is equally available to all in a signed (in a non-changeable manner) and retrievable by all. Therefore, a distributed environment suits this method. These contracts may be NDAs, tenders, purchase orders, and so forth.

STEP 8: This may in some cases require individuals to prove their identity and this can take many forms from dealing with drivers licenses to utility bills being signed off in person, or by other electronic methods such as inputting passport numbers, driving license numbers and so forth.

STEP 9: If the recipient is on-line, then messages are sent straight to them for decoding.

STEP 10: If the recipient is not on-line, messages are required to be buffered in a similar manner as required with contemporary e-mails.

STEP 11: Unlike today's email though, this is a distributed system with no servers in which to buffer. In the maidsafe.net system, messages are stored on the network encrypted with the receivers public key. Buffer nodes employed may be known trusted nodes or not.

STEP 12: Messages will look like receiver's ID. message 1.message 2, or simply be appended to the users MPID chunk; in both cases messages are signed by the sender. This allows messages to be buffered in cases where the user is offline. When the user comes on-line, he/she will check his/her ID chunk and look for appended messages as above ID. message and so forth, which is MPID.<message 1 data>.<message 2 data> and so forth.

This system allows for automatic system messages to be sent, namely in the case of sharing the share, data maps can exist on everyone's database and never be transmitted or stored in the open. File locks and changes to the maps can automatically be routed between users using the messenger system as described above; this is due to the distributed nature of maidsafe.net network and is a great, positive differentiator from other messenger systems. These system commands will be strictly limited for security reasons, and will initially be used to send alerts from trusted nodes and updates to share information by other shares of a private file share (whether they are speaking with them or not).

A best way within the maidsafe.net system to get rid of e-mail spam is to get rid of e-mail servers; a lack of e-mail servers is a distinguishing feature of the maidsafe. net network.

Next, Anonymous Transactions will be described with reference to FIG. 1 in association with the functional element P24. Such anonymous transaction are optionally, for example, implemented in Bitcoin or similar.

According to a related aspect of the present disclosure, the ability to transact in a global digital medium is made available with embodiments of the present disclosure. This is achieved by passing signed credits to sellers in return for goods. The credits are data chunks with a given worth preferably 1, 5, 10, 20, 50, 100 and so forth units (called “cybers” in this case, wherein such cybers optionally relate to bitcoins, as described in the foregoing). These cybers are a digital representation of a monetary value and can be purchased as described below or earned for giving up machine resources such as disk space of CPU time and so forth. There should be preferably many ways to earn cybers, for example in a similar manner to data mining for earning bitcoins.

A cyber, for example as exemplified by bitcoins, is actually a digitally signed piece of data containing the value statement, for example 10 cybers and preferably a serial number. During a transaction, the seller's serial number database is checked for validity of the cyber alone. The record of the ID used to transact is preferably not transmitted or recorded. This cyber will have been signed by the issuing authority as having a value. This value will have been proven, and preferably will initially actually equate to a single currency, for instance linked to a Euro. This will preferably alter through time as the cyber currency system increases in capability.

Some sellers may request non-anonymous transactions, and, if the user agrees, he7she will then use the public ID creation process to authenticate the transaction, and may optionally have to supply more data. However, there are potentially other sellers who will sell anonymously. This has a dramatic effect on marketing and demographic analysis, and s forth, as some goods will sell anywhere and some will not. It is assumed that this system allows privacy and freedom to purchase goods without being analysed.

The process of transacting the cybers will preferably involve a signing system, such that two people in a transaction will actually pass the cyber from the buyer to the seller. This process will preferably alter the signature on the cyber to the sellers signature. This new signature is reported back to the issuing authority.

Next, there will described an Interface with Non-Anonymous Systems with reference of FIG. 1 and the functional element P23 associated therewith.

According to a related aspect of the present disclosure, people may purchase digital cash or credits from any seller of the cash. The seller will preferably create actual cash data chunks which are signed and serialised to prevent forgery. This is preferably accountable as with contemporary actual cash, to prevent fraud and counterfeiting. Sellers will preferably be registered centrally in some cases. The users can then purchase cybers for cash and store these in their database of files in a system preferably such as the maidsafe.net system.

As a cyber, mutatis mutandis a bitcoin, is purchased, it is preferably unusable and in fact simply a reference number used to claim the cyber's monetary value by the purchasers system. This reference number will preferably be valid for a period of time. The purchaser then logs into their system such as maidsafe.net and inputs the reference number in a secure communications medium as a cyber request. This request is analysed by the issuing authority and the transaction process begins. Preferably, the cyber is signed by the issuing authority that then preferably encrypts it with the purchaser's public key and issues a signing request. The cyber is not valid at this point. Only when a signed copy of the cyber is received by the issuing authority is the serial number made valid and the cyber is live.

This cyber now belongs to the purchaser and validated by the issuer. To carry out a transaction, this process is preferably carried out again, namely the seller asks for payment and a cyber signed by the buyer is presented; this is validated by checking with the issuer that the serial code is valid and that the buyer is the actual owner of the cyber. Preferably, the buyer issues a digitally signed transaction record to the issuing authority to state he/she is about to alter that cyber's owner. This is then passed to the seller who is requested to sign it. The seller then signs the cyber and requests the issuing authority to accept him/her as new owner via a signed request. The authority then simply updates the current owner of the cyber in their records.

These transactions are preferably anonymous, as users should be using a private ID to accomplish this process. This private ID can be altered at any time but the old ID should be saved to allow cyber transactions to take place with the old ID.

Practical examples of possible utilisations of the system include:
I. Identification of credit card data linking the identity to a known name in another secure location. People could have a card and a revocation card or, perhaps preferably, directly use key-pairs as described in this paper. Single continuous validation systems where a known identity can be used across multiple web sites or on-line systems that require history to operate effectively;
II. A financial transaction system for implementing transfer of funds, wherein it is essential that security is maintained, that data representative of funds cannot be altered by unauthorized parties, that the parties are verifiable to be bona fide, and that a reliable audit trail can be established. With many contemporary fiat currency system s now in great difficulty, with debt rising exponentially, many financial experts have advocated that there is a need to return to a Gold standard, as pertained in an early part of the 20^{th} Century. However, Gold is an awkward material to handle in daily life when performing financial transactions, for example for exchange of monetary consideration between mutually trading entities. A contemporary problem is that, having departed from the aforementioned Gold standard, fiat currency is employed, which is increasingly represented by data in data communication systems. As data can be generated in huge quantities by computers, there clearly potentially exists a possibility of unauthorised data creation, resulting in hyperinflation within a fiat currency system. For example, when in difficulty, many governments revert to creating new money, which ultimately can lead to hyperinflation and other associated problems. Embodiments of the present disclosure enable a financial system to be established which potentially makes possible a more stable national economy, with advantages of enabling financial transactions to occur electronically. Optionally, data representative of money are associated with quantities of real Gold held in a repository by an authorized party. Other precious or semi-precious materials are susceptible to being used as an alternative to Gold in aforementioned examples, for example rare-earth elements, Silver, Palladium and so forth.

Next, there will be described Anonymity with reference to FIG. 1 and its associated functional element P25.

According to a related aspect of the present disclosure, a system of voting which is non refutable and also anonymous is to be considered. This is a requirement to allow free speech and thinking to take place on a global scale without recrimination and negative feedback, as is often the case.

To partake in a vote, the user has to be authenticated as above, and then preferably is presented with the issue to be voted upon. The user then uses a private ID key to sign his/her vote anonymously. Preferably, non-anonymous irrefutable voting optionally also takes place in the maidsafe.net system by simply switching from a private ID to a public one. This preferably forms the basis of a petition-based system, namely as an add-on to the voting system.

The system optionally requires that a block of data can be published (preferably broadcast to each user via messenger) and picked up by each user of the system, and presented as a poll. This poll is then signed by the user and sent back to the poll issuer, whose system then counts the votes and preferably shows a constantly-updated indication of the votes to date.

As there are public and private ID's available, then each vote requires preferably only one ID to be used to prevent double voting. Preferably, geographic IP is optionally used to establish geographic analysis of the voting community particularly on local issues.

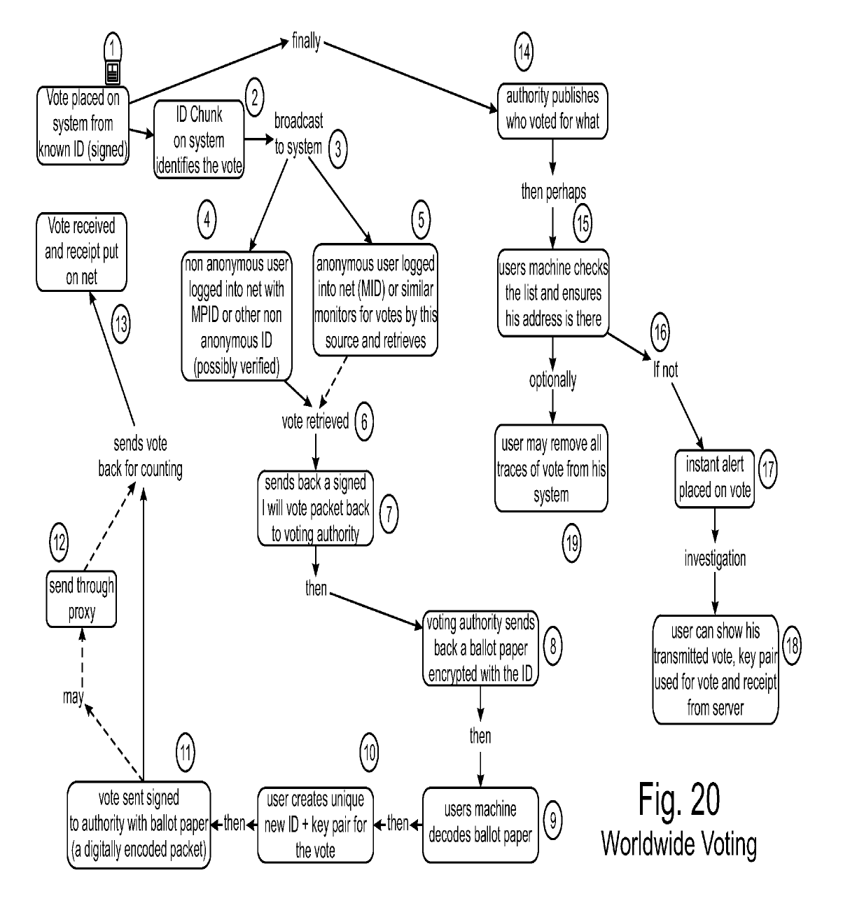

Next, there will be described a Voting System with reference to FIG. 1 and its associated principal element PT8, and also with reference to FIG. 20. There is provided a method having following steps:

STEP 1: A vote is created in a normal fashion; it could be a list of candidates or a list of choices that users have to select. Preferably, this list always has an “I do not have enough information” option appended to the bottom of the list, namely to ensure voters have sufficient knowledge to make a decision. A limit on the last option is beneficially stipulated as a limit to void the vote and redo with more information.

STEP 2: This vote is stored on the system with the ID of the voting authority. This is optionally a chunk of data called with a specific name and digitally signed for authenticity. All storage nodes may be allowed to ensure certain authorities are allowed to store votes, and only store votes digitally signed with the correct ID.

STEP 3: A system broadcast is optionally used to let everyone interested know that there is a new vote to be retrieved. This is an optional step to reduce network congestion with constant checking for votes; other similar systems may be used for the same ends.

STEP 4: A non-anonymous user logged into the maidsafe.net network (namely implemented to accommodate a voting system) is operable to pick up the vote. This is a user with a public ID known at least to the authority. The vote may in fact be a shared chunk that only certain IDs have access to or know of its location (namely is split into several component parts, and a messaging system is used to alert when votes are ready).

STEP 5: An anonymous user may be logged onto the maidsafe.net network and may in fact use a random ID to pick up the vote.

STEP 6: The vote is retrieved.

STEP 7: The system sends back a signed (with the ID used to pick up the vote) “I accept the vote”.

STEP 8: The voting authority transmits a ballot paper, namely a digitally signed (and perhaps encrypted/chunked) ballot paper. This may be a digitally signed “authorisation to vote” slip which may, or may not, be sequentially numbered, or perhaps a batch of x number of the same serial numbers (to prevent fraud by multiple voting from one source, namely an. issue of 5 same numbers randomly and only accept 5 votes with that number).

STEP 9: The user machine decrypts this ballot paper.

STEP 10: The users system creates a one time ID+key pair to vote. This public key can be hashed and stored on the net as with a MAID or PMID, so as to allow checking of any signed or encrypted votes sent back.

STEP 11: The vote is sent back to the authority signed and preferably encrypted with the authority's public key.

STEP 12: In the case of anonymous or non-anonymous voting, this may be further masqueraded by passing the vote through proxy machines en route.

STEP 13: The vote is received and a receipt chunk put on the maidsafe.net network. This is a chunk called with the users temp (or voting) ID hash, with the last bit shifted or otherwise knowingly mangled, so as not to collide with the voting ID bit the user stores for authentication of their public key.

STEP 14: The authority can then publish a list of who voted for what (namely a list of votes and the voting ID's)

STEP 15: The user's system checks the list for the ID that was used being present in the list, and then validates that the vote was cast properly.

If this is not the case in STEP 15, then:

STEP 16: The users system issues an alert. This alert may take many forms and may include signing a vote alert packet; this can be a packed similarly (as in STEP 13), namely altered to be a known form of the vote chunk itself. There are many forms of raising alerts, including simply transmitting an electronic message through messenger or similar, and optionally to a vote authentication party and not necessarily the voting authority themselves.

STEP 17: The user has all the information to show the party investigating voting authenticity, accuracy, legality or some other aspect, thereby allowing faults and deliberately introduced issues to be tracked down.

STEP 18: The user has the option to remove all traces of the vote from his system at this time.

Next, there will be described Proven Individual functionality of the maidsafe.net system, with reference to FIG. 1, and its associated functional element P26.

According to a related aspect of the present disclosure, using a system of anonymous authentication preferably as in maidsafe.net, the first stage is partially complete and individual accounts are authentic, but this does not answer the question of anonymous individuals; this is described here.

Access to a system can be made with information that a given user possess (for example passwords and so forth), or something that the given user physically has (for example, iris/fingerprint or other biometric test). To prove an individual's identity, the system preferably uses a biometric test. This is a key to the voting system, when it becomes more broadly adopted. It is inherent in this system that any personally identifying data must be kept secret, and also that any-2086-passwords or access control information is never transmitted.

When a user authenticates, the system can recognise whether or not they have done so biometrically. In this case, the account is regarded as a unique individual rather than an individual account. This is possible as the maidsafe.net system can authenticate without accessing servers or database records of a biometric nature for example.

As a given user logs into the maidsafe.net network through a biometric mechanism, then the state of login is known, so no login box is presented for typing information into access the system. This allows the system to guarantee that the user has logged in biometrically. The system on each machine is always validated by the maidsafe.net system upon login, namely to ensure this process cannot be compromised.

Preferably, some votes will exist only for biometrically authenticated users.

Next, Distributed Controlled Voting will be described in greater detail with reference to FIG. 1 and its associated function element P29.

According to a related aspect of the present disclosure, to manage the system further, there is provided a level of control as well as distribution to enable all users to access it at any time. The distribution of the votes is beneficially controlled as system messages and stored for users using the messenger system as described earlier.

A main issue with a system such as this would be ‘what’ is voted on and who poses the votes and words polls. This is key to the fairness and clarity of the system and process. This voting system beneficially preferably always has a ‘not enough information’ selection to provide a route by which users are able to access information, so that they are well informed before making any decision.

The system requires a group of individuals, who are preferably voted into office by the public as the policyholders/trustees of the voting system. This group is beneficially known by their public ID and use their public ID to authenticate and publish a poll. This group is preferably voted into office for a term and is optionally susceptible to being removed at any time via a consensus of the voting public. For this reason, there are optionally continual polls on-line, which reflect how well policyholders are doing as a group, and preferably individually as well.

According to a related aspect of the present disclosure, users of the system beneficially input to the larger issues on the system. Macro management is beneficially implemented via the policyholders of the system, whom as mentioned previously may be voted in or out at any time; however larger issues should be left to the users. These issues can preferably be what licenses are used, costs of systems, dissemination of charitable contributions, provision to humanitarian and scientific projects of virtual computing resources on large scales, and so forth.

To achieve this, preferably a system message will be sent out, where it is not presented as a message but as a vote. This should show up in the users voting section of the system. User private IDs will be required to act on this vote and they can make their decision.

There are optionally appeals on these votes, when it is apparent that a conclusion of the vote is dangerous to either a small community, or the system as a whole. Users optionally have an option of continuing with the vote and potential damage, but essentially the user will decide and that will be final. Preferably, this system does not have a block vote or any other system which rates one individual over another at any time or provides an advantage in any other way. This requires no ability to allow veto on any decision or casting of votes by proxy, so that the authenticated user's decision is seen as properly recorded and final.

According to a related aspect of the present disclosure, a system of perpetual data, self encrypting files and data mapping allows a global anonymous backup and restore system for data to exist. This system can be constructed from one or more of the previously described embodiments, wherein data may be made perpetual on a network and anonymously shared to prevent duplication. This, together with the ability to check, manipulate and maintain revision control over files, adds the capability of a time machine′ type environment where data may be time-stamped on backup.

This allows a system to rebuild a user's data set as it was at any time in history since initial use of maidsafe.net network or similar technologies. This optionally forms a defense at times when, in cases like prior art enquiries, insider dealing and so forth is being considered, as the system is secure and validated by many other nodes and so forth. It can therefore be shown what knowledge (at least from a point of view of owning data pertaining to a subject,) anyone had of certain circumstances.

According to a related aspect of the present disclosure, preferably using one or more aspects which are previously defined, or by employing any that may improve this situation. Taking distributed authentication, backup and restore along with data map sharing, the maidsafe.net system can add to this the ability for granular access controls. In this case, a node entering the maidsafe.net network will request an authenticator to authorise its access. In this case, the authenticator is a manager or equivalent in an organisation, whether matrix managed or a traditional pyramid arrangement. This authorisation tiet the public ID of the authoriser to the system as having access to this node's data, and any other authorisations they make (namely in an authorisation chain). This allows an environment of distributed secure backup, restore and sharing in a corporate or otherwise private environment.

According to a related aspect of the present disclosure, all of the capabilities described herein, beneficially ensure that a network of nodes can be created, in which users have security privacy and freedom to operate.

These nodes beneficially have refutable IDs (MAID, PMID and so forth) as well as no-refutable IDs (MPID) for different purposes

According to a related aspect of the present disclosure, adding an ability of non-refutable messaging allows users not only to communicate genuinely and securely, but also an ability to communicate under contractual terms. This allows for the implementation of legally-kept trade secrets (as implied with NDA agreements and so forth) together with many more contractual communications. This will hopefully lessen a burden on legal issues such as litigation and so forth.

According to a related aspect of the present disclosure, adding an ability to create two voting systems, anonymous and non-anonymous, allows the system to provide a mechanism for instant democracy. This is achieved by allowing a voting panel in a users account that is constantly updated with issues regarding the system and initially its improvements. These votes are beneficially anonymous.

In another anonymous voting scenario, users optionally continually vote on certain subjects (as in a running poll), wherein these subjects are optionally the leaders of boards, and so forth.

In a non-anonymous voting scenario, it may be there are groups of identified people (via their MPID) who have a common grouping such as a charity or similar, and they may require certain people to vote on certain matters and be recognised. This is where the MPID is used for voting.

According to a related aspect of the present disclosure, adding to this an ability to collect and trade credits anonymously allows users to sell machine resources that they are not using, and to trade on a network with a cash equivalent, for example a cyber currency such as bitcoins, and go about their business on a network as they do in real life.

According to a related aspect of this present disclosure, there is provided a system of self-encryption of data that does not require user intervention or passwords. The resultant data item then has to be saved or stored somewhere as in all methods. The self-encryption system creates cipher-text (encrypted) objects that are extremely strong and closer to perfect in terms of reversibility, and produce difficult-to-guess uncompressable output. The difficult-to-guess and uncompressable output equates to random results based on random input data and random, unrelated algorithm inputs plain text, key and initialisation vectors in the case of modern symmetric ciphers. The self-encryption system includes a file chunking module, file encryption module, and a file obfuscation module.

The file chunking module splits an input data into several data chunks (Cₙ) based on the size of data file (f.size( )) and total number of data chunks. The total number of data chunks may depend on maximum number of data chunks, or maximum chunk size specified by the user. In an example, the input data may be divided into chunks of size 256 kB. The file chunking module beneficially further takes a hash of each data chunk, and hashes the hashed data chunks to create a structure, referred to as a data map. The file content, namely input data is referred to as f_{c}, file metadata is referred to as fₘ, and file hash

fₕ≡H(f_{c})orfh≡H(H(C₁)+H(C₂)+ . . . H(Cₙ₋₁)) (1)

The data chunks are created with fixed size to ensure the set required to recreate the file is almost as large as the number of available data chunks in any data store. This data map is mapped to file metadata through fₕ.

In cryptographically secure hashing, the input data is analysed and a fixed length key called the hash of the data is produced. A cryptographically secure hash is a one way function which creates output that has a uniform distribution and can be computed in polynomial time. The output should be in fact random, although can be affected by a size of input. The size of input required is dependent on the strength of the hash functions employed. A hash function can be thought of as a digital fingerprint. Just as a fingerprint of a person is supposed to be unique, then a digital hash function is also supposedly unique. Two data pieces with the same hash result leads to a collision, The more secure the hash algorithm, then the likelihood of a collision is reduced. Again, similar to human fingerprinting, a hash cannot reveal data, just as a fingerprint cannot reveal a person (i.e. the person cannot be recreated from the print and the data cannot be recreated from hash).

The file encryption module uses two separate non-deterministic pieces of data, i.e, the encryption key (or password) and an initialisation vector (IV) for encryption of a data chunk. To ensure all data chunks of a file encrypt to the same end result, the IV is determined from non-deterministic data, i.e. hash of one of the data chunks. The encryption of data with encryption key and IV can be represented by Enc_{[key][IV]} (data), where the key and the IV for encryption of n^{th} chunk are derived from separate portions of the hash of n−1^{th} chunk. In an example, when the encryption algorithm is AES, the first 32 bytes of the hash of n−1^{th} chunk are beneficially presumed to be the key and the next 16 bytes are beneficially presumed to be the IV, and an encrypted data chunk Cₓₑₙ is then formed from a data chunk Cₓₙ using hash of a n−1^{th} data chunk Cₙ₋₁, such that

Cₓₑₙ≡EnC_{[H(C}_{_{n−1[first32bytes])]}}_{[H(C}_{_{n−1[32-48 bytes])]}}(Cₓₙ) (2)

The hash of the encrypted data chunk Cₓₑₙ is conveniently represented as H_{C}_{ₓₑₙ} and the encrypted chunk Cₓₑₙ is then beneficially renamed with the corresponding hash H_{C}_{ₓₑₙ}.

The file obfuscation module pollutes a data chunk with data from other data chunks. In an example, for obfuscating an n^{th} data chunk Cₙ, firstly an identically-sized data chunk is created by repeatedly rehashing the hash of n+2^{th} chunk Cₙ₊₂ and appending the result, i.e. H(Cₙ₊₂)+H(H(Cₙ₊₂))+H(H(H(Cₙ₊₂)))+ . . . . This identically-sized data chunk may be referred to as XOR n^{th} chunk (C_{XORn}). Then, the XOR n^{th} chunk (C_{XORn}) is XORed (⊕) with n^{th} data chunk Cₙ to determine an obfuscated n^{th} chunk Cₓₙ.

In an example, a first obfuscated data chunk Cₓ₁≡C_{XOR1}⊕C₁, a second obfuscated data chunk Cₓ₂≡C_{XOR2}⊕C₂, and so forth. Although, XOR has been selected to represent a logical operation to obfuscate the data, this is not restrictive in any way and may be replaced by other obfuscation methods.

TABLE 8
A method of self-encrypting data using the file chunking, file
encryption, and file obfuscation modules

| Step | Detail |
|---|---|
| 1. | Split an input data into several chunks (Cₙ). |
| 2. | Take hash of each chunk (H_{c}_{ₙ}). |
| 3. | In case of AES or similar cypher, use [keysize] (Cₙ₋₁) as |
| | the key, use [next bytes](Cₙ₋₁) as the initialisation |
| | vector (IV); (for AES 0 to 32 bytes == key and 32 to 48 |
| | bytes == IV). |
| 4. | Create obfuscation chunk (OBFCₙ) by concatenating the |
| | hashes of other chunks ([unused part of] Cₙ₋₁ Cₙ₋₂ and |
| | Cₙ). |
| 5. | Run encryption cypher or similar reversible method on |
| | (Cₙ), to produce (C_{random}). |
| 6. | Now data is considered to be randomised and of the |
| | same length as input data. |
| 7. | OBFCₙ is also random output, but of a length less than |
| | the input data. |
| 8. | Take OBFCₙ (repeated) XOR C_{random} to produce |
| | output data. |
| 9. | Rename each with the hash of the new content and save |
| | these hashes. |

In the aforementioned method of encrypting data, the encryption of the data chunks and then thereafter XOR′ing them together, namely for obfuscation purposes, provides synergistically extremely secure data, which is substantially impossible to decrypt, even using extremely powerful modern computers. When the obfuscation is performed before encryption, a much inferior result in terms of data security is obtained. The encryption followed by XOR obfuscation is very robust, as aforementioned.

The symmetric encryption algorithm (AES) introduces randomness to the data, and the obfuscation module repeats random data. Therefore, the self-encryption process can be considered substantially, for practical purposes, as a form of one time pad.

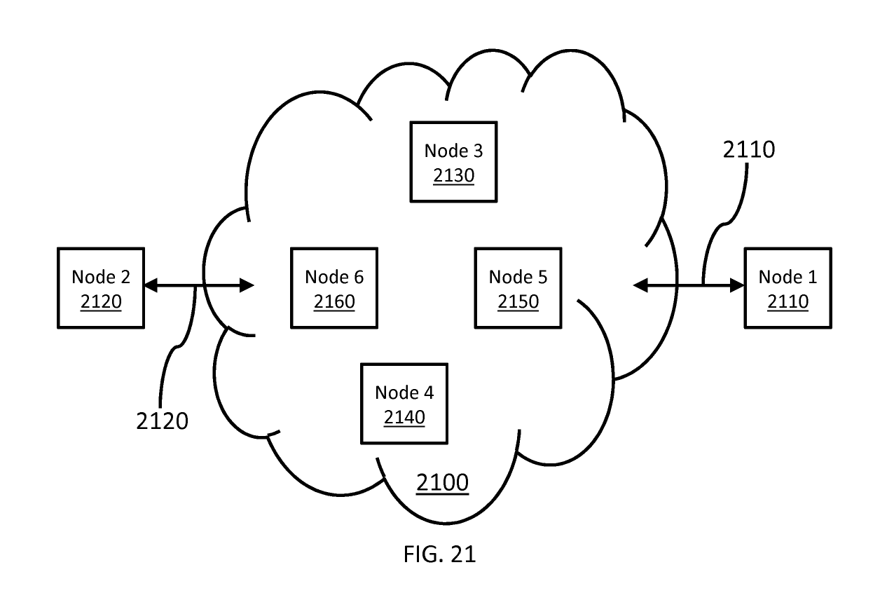

Referring to an example illustrated in FIG. 21, conferencing data such as video conferencing data, audio teleconferencing data or both of these may be the subject of the systems, methods and computer program products for storing data of a first node on a peer-to-peer network in a protected form. This data may represent any of a variety of media including but not limited to presentation data, documents, video footage and audio footage. When a Node 2110 and a node 2120 are cooperating in a peer-to-peer communications network 2100 and desire to engage in a conferencing session, encrypted and obfuscated conferencing data of node 2110 may be stored in a protected form across cooperating nodes 2130, 2140, 2150 and 2160. Node 2120, engaged in a conferencing session with node 2110 may subsequently decrypt and deobfuscate the protected form of the conferencing data previously stored in a distributed manner on nodes 2130, 2140, 2150 and 2160. In a two-way conferencing session, node 2120 may also provide original conferencing data for encryption, obfuscation and storage in a protected form. As such, node 2110 may then decrypt and deobfuscate the protected form of the data for interpretation. Flow of conferencing data is indicated by arrows 2210 and 2220.

In some examples, nodes 2110 and 2120 are also contribute resources to data storage. Thus, nodes 2110 and 2120 may form a part of peer-to-peer communications network 2100. Furthermore, while only six total nodes have been illustrated, it will be appreciated that any number of nodes may provide for storing the protected form of the data and any number of nodes may participate in a conferencing session using the conferencing data.

Data Map: The data maps facilitate retrieval of plain-text from the cipher-text (encrypted) data chunks.

TABLE 9
Data map structure
fh = H(H(c₁) + H(C₂) + . . . H(Cₙ₋₁))

| | |
|---|---|
| H(c₁) | H(cₓₑ₁) |
| H(c₂) | H(cₓₑ₂) |
| . . . | . . . |
| H(cₙ) | H(cₓₑₙ) |

In the aforementioned data map structure, the file hash fₕ in the top row identifies the data and acts as the unique key for the input file. The left-hand-column includes all the passwords and IV's, which are derived from the original chunk hashes, and the right-hand-column include names of all the encrypted and obfuscated data chunks. The data map structure facilitates retrieval of plain-text from the cipher-text chunks, where the retrieval process includes:
I. Retrieving the chunks listed in right hand column
II. Creating each XOR chunk again
III. Reversing the obfuscation stage
IV. Decrypting each result
V. Concatenating the results.

Data Atlas or Recursive Data Maps:

The data maps (dₘ) from multiple files can be concatenated into a new structure, referred to as a data atlas (dₐ), where dₐ≡dₘ₁+dₘ₂+ . . . d_{mc}. This data atlas is itself now a large piece of data and may be fed into the self-encryption process, to produce a single data map and more data chunks. The data chunks may be stored somewhere and the single remaining data map may be the key to all data.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

What is claimed is:

1. A computer-implemented method of storing data of a first node on a peer-to-peer communications network in a protected form, the method comprising steps of:
obfuscating the first node data by splitting the first node data into a plurality of data chunks;
generating the protected form of the first node data by swapping data between the data chunks and encrypting the data chunks by applying an encryption algorithm;
storing the protected form of the first node data on the peer-to-peer communications network;
creating a public and private key pair from the first node data; and
assigning a hash value for the public key as an identifier for the user of the node.

2. The method as claimed in claim 1, further comprising establishing a hash value for the first node data, and determining, from the established hash value, at least one of data chunk size and data chunk number.

3. The method as claimed in claim 1, wherein applying the encryption algorithm further comprises applying a symmetric encryption algorithm.

4. The method as claimed in claim 1, wherein swapping data between the data chunks further comprises using an XOR operation.

5. The method as claimed in claim 1, wherein the method comprises determining a hash value for each data chunk, and thereafter renaming each data chunk using the determined hash value of that data chunk.

6. The method as claimed in claim 1, wherein encrypting the data chunks further comprises employing a known portion of data from the first node data as an encryption key.

7. The method as claimed in claim 6, wherein encrypting further comprises encrypting each data chunk separately using known information from another of the data chunks as the encryption key.

8. The method as set forth in claim 1, wherein storing the protected form of the first node data on the peer-to-peer communications network further comprises storing the protected form of first node data on a plurality of nodes of the peer-to-peer communications network.

9. The method as claimed in claim 8, wherein the method comprises recording identities of the protected data in one or more data maps for retrieving and/or validating authenticity of the protected form of the first node data.

10. The method as claimed in claim 8, wherein storing the protected form of first node data further comprises determining whether one or more of the data chunks already exist on the distributed network and, storing the one or more data chunks only when the one or more of the data chunks do not already exist on the distributed network.

11. A computer program product comprising a non-transitory computer-readable storage medium having computer-readable instructions stored thereon, the computer-readable instructions being executable by a processing hardware to cause one or more computers to:
obfuscate data of a first node data of a peer-to-peer communications network by splitting the first node data into a plurality of data chunks;
generate a protected form of the first node data by swapping data between the data chunks and encrypting the data chunks by applying an encryption algorithm;
store the protected form of the first node data on the peer-to-peer communications network;
create a public and private key pair from the first node data; and
assign a hash value for the public key as an identifier for the user of the node.

12. The computer program product as claimed in claim 11, wherein the instructions further cause the one or more computers to establish a hash value for the first node data, and determine, from the established hash value, at least one of: data chunk size and data chunk number.

13. The computer program product as claimed in claim 11, wherein the instructions causing the one or more computers to apply the encryption algorithm further cause the one or more computers to apply a symmetrical encryption algorithm.

14. The computer program product as claimed in claim 11, wherein the instructions which cause the one or more computers to swap data between the data chunks further cause the one or more computers to employ an XOR operation.

15. The computer program product as claimed in claim 11, wherein the instructions further cause the one or more computers to determine a hash value for each data chunk, and thereafter rename each data chunk using the determined hash value of that data chunk.

16. The computer program product as claimed in claim 11, wherein the instructions causing the one or more computers to encrypt the data chunks further cause the one or more computers to employ a known portion of data from the first node data as an encryption key.

17. The computer program product as claimed in claim 16, wherein the instructions causing the one or more computers to employ the known information from another of the data chunks as the encryption key further cause the one or more computers to encrypt each of the data chunks separately.

18. The computer program product as claimed in claim 10, wherein the instructions causing the one or more computers to store the protected form of the first node data further cause one or more computers to store the protected form of the first node data on a plurality of nodes of the peer-to-peer communications network

19. The computer program product as claimed in claim 10, wherein the instructions further cause the one or more computers to record identities of the protected data in one or more data maps for retrieving and/or validating authenticity of the protected form of the first node data.

20. The computer program product as claimed in claim 10, wherein the instructions causing the one or more computers to store the protected form of first node data further cause the one or more computers to determine whether one or more of the data chunks already exist on the distributed network and, store the one or more data chunks only when the one or more of the data chunks do not already exist on the distributed network.

21. A system for storing data of a first node in a protected form, comprising:
a peer-to-peer communications network comprising a plurality of nodes;
a file chunking module configured to split the first node data into a plurality of data chunks;
file encryption module arranged to encrypt the data chunks by applying an encryption algorithm;
a file obfuscation module configured to swap data between the chunks; and
a processor arranged to:
create a public and private key pair from the first node data;
assign a hash value for the public key as an identifier for the user of the node;
employ the file chunking module, the file encryption module and the file obfuscation module to generate a protected form of the first node data; and
store the protected form of the first node data on the peer-to-peer communications network.
